(19) United States
(12) Patent Application Publication
(10) Pub. No.: US 2026/0330151 A1
(43) Pub. Date: Oct. 22, 2026

(54) Agentic AI System for Dynamic Customer Journey Orchestration

(71) Applicant: Michael Raymond Cantow, Mahwah, NJ (US)

(72) Inventor: Michael Raymond Cantow, Mahwah, NJ (US)

(21) Appl. No.: 19/650,255

(22) Filed: Apr. 16, 2026

Related U.S. Application Data
(60) Provisional application No. 63/789,488, filed on Apr. 16, 2025.

(51) Int. Cl. G06F 40/40; G06Q 30/015

(52) U.S. Cl. CPC G06F 40/40; G06Q 30/015

(57) ABSTRACT

A deterministic execution layer constrains probabilistic large language model outputs through enforced structural validation and state-controlled progression. A finite state machine defines allowable conversational states and transitions. At each state, a scoped prompt is transmitted to a large language model to produce a candidate response. Each candidate response is validated against a predetermined machine-parseable output schema comprising a message field and a structured update field. State transitions are permitted only upon successful schema validation; on validation failure, the current state is maintained and a re-engagement prompt is generated. Validated structured update fields are routed via a dispatch table to consumer action handlers that execute database mutations within atomic transactions with row-level locking. A contextual pruning algorithm produces reduced context for downstream agents using stage isolation rules, markup removal, and deterministic inclusion criteria.

### CROSS-REFERENCE TO RELATED APPLICATIONS

This application claims the benefit of U.S. Provisional Application No. 63/789,488, filed Apr. 16, 2025, entitled “Agentic AI System for Dynamic Customer Journey Orchestration,” which is incorporated herein by reference in its entirety.

### FIELD OF THE INVENTION

The present invention relates to deterministic control architectures that constrain probabilistic large language model (LLM) output through enforced structural validation and state-controlled progression. More specifically, the invention relates to systems in which a finite state machine (FSM) governs conversational state, a predetermined machine-parseable output schema gates state transitions, a dispatch table routes validated structured outputs to deterministic consumer action handlers executing atomic database mutations with row-level locking, and a contextual pruning algorithm produces bounded context handoffs between AI agents operating within a shared contextual state. The invention further relates to directed-acyclic-graph-based scheduling with workday-aware date propagation for generating deployment plans from structured upstream outputs. The invention eliminates the need for static workflows, predefined logic trees, or per-tenant model training.

### BACKGROUND OF THE INVENTION

### Technical Field

The present invention is in the field of control architectures for probabilistic AI systems. More particularly, the invention relates to systems and methods for converting non-deterministic large language model generation into deterministic, auditable system behavior through finite state machine governance, schema-based output validation, and dispatch-table-routed consumer action handlers executing atomic database mutations.

### Description of Related Art

Traditional customer engagement platforms depend on one or more of the following approaches: (1) manually designed workflows in which a human operator defines each step, branching condition, and transition rule; (2) rigid rule-based decision trees that encode fixed conditional logic for routing customers through predetermined paths; or (3) bespoke AI models requiring training and tuning on proprietary datasets for each tenant, user, or deployment context.

Each of these approaches presents substantial limitations.

Manually designed workflows require significant human expertise and labor to construct, test, and maintain. As the number of customer segments, product configurations, and engagement scenarios grows, the combinatorial complexity of maintaining such workflows becomes prohibitive. Changes to any workflow element require manual re-authoring, testing, and deployment, resulting in delayed time to value.

Rule-based decision trees impose rigid conditional logic that cannot adapt to novel customer inputs, unexpected interaction patterns, or evolving business requirements without manual restructuring. These systems are inherently brittle: each new edge case requires explicit encoding, and the resulting decision structures become increasingly difficult to audit, modify, and scale.

Bespoke AI models requiring per-tenant or per-user training introduce prohibitive costs in data collection, annotation, model development, and ongoing maintenance. These models require access to proprietary training datasets, raising compliance concerns related to data privacy, residency, and regulatory requirements. The training cycle imposes delayed time to value, as each new deployment requires data accumulation, model training, validation, and integration before the system becomes operational.

Existing conversational AI systems, including chatbot frameworks and retrieval-augmented generation systems, lack deterministic control over conversational flow. These systems permit the underlying language model to determine conversational transitions autonomously, resulting in unpredictable interaction paths, hallucinated outputs, and an inability to guarantee schema-compliant structured outputs at each interaction step. The absence of formal state machine governance, schema-based output validation, and gated state progression renders these systems unsuitable for processes where auditability, explainability, and deterministic behavior are required. Systems that validate LLM output without gating state progression on that validation still permit state advancement in the presence of malformed output; systems that gate state progression without binding the validated output to deterministic backend effects through a dispatch table still rely on ad hoc routing logic that must be manually maintained.

Prior multi-agent AI systems that coordinate multiple specialized agents lack formal mechanisms for structured context handoff between agents. Without contextual pruning, downstream agents receive either the full accumulated context (resulting in increased computational cost and decreased relevance) or an ad hoc subset of prior outputs (resulting in information loss and inconsistent agent behavior).

Prior predictive scoring systems in customer engagement contexts rely on static feature sets, manually calibrated weights, or supervised models trained on labeled historical data. These approaches require ongoing model maintenance, are sensitive to distribution shift, and lack explainability at the individual prediction level.

Prior deployment planning systems rely on static scheduling templates, manually sequenced task lists, or basic project management tooling that does not account for the structured outputs of upstream customer journey phases. These systems treat deployment planning as an isolated function rather than as a downstream consequence of earlier discovery, evaluation, and scoping interactions.

There remains a need for a control architecture that converts non-deterministic large language model generation into deterministic, auditable system behavior by (i) governing model invocation through finite state machines defining allowable states and transitions, (ii) validating each candidate model output against a predetermined machine-parseable schema before permitting any state transition, (iii) binding validated outputs to deterministic consumer action handlers through a dispatch table such that a single validated output produces both a state transition and an atomic database mutation, (iv) generating pruned context for downstream agents through a deterministic algorithm with parameterized inclusion rules, and (v) operating across multiple agent types and multiple sequential execution phases without requiring model training, static workflows, or predefined logic trees.

### SUMMARY OF THE INVENTION

### Technical Problem and Unconventional Technical Solution

The present invention is directed to a specific technical problem: integrating a probabilistic generation component (a large language model) with a deterministic downstream execution pipeline without permitting the probabilistic component's non-determinism to propagate into the deterministic pipeline. Prior approaches either (a) treated language model output as directly actionable, accepting unpredictable system behavior as a consequence, or (b) wrapped language model output in ad hoc quality checks that did not gate state progression, permitting malformed output to reach persistent state. Neither approach produces deterministic, auditable system behavior driven by probabilistic model output.

The present invention provides an unconventional technical solution. The invention transforms probabilistic large language model output into deterministic system behavior by (i) enforcing structural validation of each candidate model output against a predetermined machine-parseable schema, (ii) gating state transitions exclusively on successful schema validation such that no state change occurs from a non-conforming output, and (iii) binding each validated output, through a dispatch table, to a consumer action handler that executes a corresponding database mutation within a single atomic transaction with row-level locking, such that state transition and persistent data change are committed as a single indivisible operation or not at all. The combined mechanism is the sole pathway through which state change and data mutation occur within the system. This solution is not the predictable combination of known components; the coordinated operation of schema gating at the probabilistic output boundary with atomic binding of transition-to-persistence produces a technical effect-deterministic system behavior under probabilistic input not obtainable from any component in the combination considered in isolation. The claim elements recited herein embody this solution.

### The Invention as a Constrained Execution Environment

The system operates as a constrained execution environment in which probabilistic outputs from a large language model are transformed into deterministic system behavior. Structural validation of the model output is not used solely for formatting correctness, but instead functions as a gating mechanism that determines whether system state progression and persistent data mutation are permitted. Only outputs conforming to a predefined machine-parseable schema are eligible to trigger state transitions and backend execution, and such execution is performed atomically such that state evolution and data mutation occur as a single indivisible operation. Outputs that fail structural validation produce no state change, no persistent data mutation, and no client notification; upon repeated validation failures exceeding a configured retry threshold the system enters a non-progressing state that halts further state transitions until a conforming output is received or an explicit operator override is issued. The validated structured output of the language model is therefore the sole instruction set executed by the deterministic downstream pipeline, and the pipeline is the sole mechanism through which the execution instance's state and persistent data evolve.

The system does not interpret language model output as advisory, heuristic, or optional input. Once validated, the output is treated as a complete and exclusive instruction set for system execution. No alternative execution path exists within the system architecture: the deterministic execution pipeline does not generate or modify instructions independently of the validated structured output, and the probabilistic generation component is therefore structurally constrained, by the architecture of the system, to produce executable instructions conforming to a predefined machine-parseable schema or to produce no system effect at all. The result is a system that forces a probabilistic language model to behave, from the perspective of the downstream deterministic pipeline, as a deterministic instruction generator whose every accepted output carries exactly the structural form required for execution. This behavioral transformation of the probabilistic component is the technical effect of the invention; it is not a predictable result of combining a finite state machine, a schema validator, a dispatch table, and an atomic database transaction according to their established functions, because none of those components, operating under their established functions and without the specific exclusivity, gating, and atomic-binding constraints described herein, transforms a probabilistic generator into a deterministic instruction source.

### Summary of System Architecture

The present invention provides a deterministic execution layer that constrains probabilistic large language model outputs through enforced structural validation and state-controlled progression. Rather than permitting a language model to determine system behavior through free-form output, the invention operates a finite state machine that defines allowable states and transitions, transmits scoped prompts to the language model only within defined states, validates each candidate response against a predetermined machine-parseable output schema, and permits state transitions only upon successful schema validation. On validation failure, the current state is maintained, the candidate response is rejected, and a re-engagement prompt is generated within the current state. Validated structured outputs are routed through a dispatch table to deterministic consumer action handlers that execute database mutations within atomic transactions with row-level locking. The system thereby converts non-deterministic language model generation into deterministic, auditable system behavior.

The system further comprises a plurality of cooperating components that collectively enable autonomous, adaptive, and explainable management of sequential stage-scoped execution instances without reliance on predefined workflow logic, static decision trees, or model training.

In one aspect, the invention provides an AI-driven customer journey orchestration system that autonomously creates and adapts structured customer journeys in real time based on user interaction data and contextual signals, providing a dynamic layer for journey progression, refinement, and outcome optimization without predefined workflows or manual intervention.

In one aspect, the invention provides an agentic flow through customer journey phases, wherein multiple AI agents autonomously manage discrete phases of the customer journey, operating with scoped responsibilities while sharing structured context, and wherein downstream agents leverage outputs from earlier phases to enable fluid, asynchronous, and parallel orchestration without centralized control logic.

In one aspect, the invention provides a hierarchical AI agent-driven journey creation system comprising a top-level journey creator AI agent configured to generate a global blueprint for a customer journey based on minimal user input, a plurality of subordinate phase-specific AI agents each configured to refine and populate a discrete section of the journey blueprint, and a communication module configured to transmit contextual information and state transition signals between agents.

In one aspect, the invention provides a template distribution subsystem comprising a template submission module, a conformance validation module, an integration module configured to incorporate approved templates into the orchestration engine through template row identifier mapping, and a licensing module configured to record template provenance.

In one aspect, the invention provides a hierarchical AI agent-driven journey editing and refinement system comprising a supervisory editing AI agent configured to detect refinement opportunities, a CTA generator configured to dynamically produce CTAs that prompt targeted editing actions, and a plurality of phase-specific editing AI agents configured to execute non-destructive modifications to the existing customer journey while preserving structural integrity.

In one aspect, the invention provides a self-improving template engine that enables journey templates to evolve over time based on historical AI interactions, user behavior, and outcome data, by analyzing conversational patterns including skipped questions, common responses, and drop-off points, and surfacing optimization opportunities via AI agent-generated CTAs.

In one aspect, the invention provides a CTA-based transition system wherein a Call-to-Action is a system primitive comprising an action type identifier and an associated parameter set, generated based on real-time execution context, mapped through a dispatch table to a corresponding consumer action handler, and triggering both an atomic backend database mutation and a finite state machine transition upon execution, such that a single CTA directive produces a deterministic backend state change and a corresponding user interface element without separate branching logic.

In one aspect, the invention provides a smart conversation discovery AI agent comprising an input interface, a finite state machine defining a plurality of conversational states including answer-and-advance, re-engage, revise-and-reengage, and skip, a large language model configured to generate candidate responses under FSM control, and a validation module configured to compare each candidate response against a predetermined machine-parseable output schema, wherein state transitions are permitted if and only if schema validation is successful.

In one aspect, the invention provides a predictive deployment planning system that automatically generates a recommended deployment plan comprising a timeline and structured deployment actions, based on structured outputs from prior customer journey phases, including readiness indicators, user inputs, and contextual phase outcomes.

In one aspect, the invention provides state-aware planning logic wherein the deployment plan is generated using structured state data from one or more prior customer journey phases, enabling adaptive planning based on the customer's evolving state rather than static rule sets.

In one aspect, the invention provides learning-based plan optimization wherein the deployment plan is refined based on analysis of historical journey data, including actual execution times, completion rates, delay patterns, and successful implementation outcomes across previously completed journeys.

In one aspect, the invention provides a multi-tenant adaptive planning engine that dynamically adapts deployment plan recommendations across tenants by learning from anonymized outcome patterns and adjusting action recommendations and scheduling logic to align with journey segment characteristics or domain-specific benchmarks.

In one aspect, the invention provides a concurrent multi-agent state synchronization subsystem comprising a plurality of role-scoped AI agents each operating with a distinct permission level, a shared contextual state module configured to aggregate asynchronous structured outputs from each agent through time-stamped write operations with row-level locking, and an orchestration engine configured to propagate state updates to all connected clients via a real-time communication channel.

In one aspect, the invention provides an execution state monitoring subsystem comprising a monitoring module configured to track stage completion indicators, activity timestamps, and stage transition counts, a threshold evaluation module that computes time elapsed since last activity against configured thresholds, an intervention module configured to emit structured intervention signals to AI agents upon threshold breach, and an integration module configured to deliver signals through a user interface or application programming interface.

In one aspect, the invention provides an AI-based predictive scoring and outcome forecasting system comprising a data collection module, a feature extraction module configured to derive key performance indicators, a predictive engine configured to compute a score with an explainable weighted breakdown of contributing variables, and an update module configured to dynamically refine scoring parameters based on real-time feedback and historical performance data.

In one aspect, the invention provides an agentic business process architecture that enables flexible, adaptive AI-driven decision-making without static logic trees or predefined workflows, wherein AI agents respond dynamically to real-time data and contextual signals through prompt-driven inference, schema validation, and orchestrated agent transitions.

In one aspect, the invention provides a contextual pruning algorithm for generating structured context handoffs between AI agents, the algorithm comprising: receiving parameters specifying stage isolation, data minification, markup removal, and option inclusion; applying deterministic inclusion rules that preserve stage-scoped structured outputs and exclude out-of-stage data; stripping rich text markup from included fields according to a predefined markup specification; and outputting a reduced data representation whose content is fully determined by the input parameters and the shared contextual state at invocation time.

In one aspect, the invention provides a zero-training AI system architecture that enables creation and coordination of specialized AI agents using foundational large language models without per-tenant or per-user fine-tuning, wherein specialization is achieved through structured prompt engineering, AI agent role definition, contextual chaining, and FSM-governed execution.

In one aspect, the invention provides a pluggable LLM architecture with user-selectable models, wherein AI agents operate independently of any specific LLM implementation, enabling users to select models based on performance, cost, latency, or privacy requirements, and supporting flexible deployment across public, private, or hybrid LLM compute environments without reconfiguration.

In one aspect, the invention provides a first-party AI system for direct customer insight acquisition and action that engages users to capture structured, real-time interactions without relying on third-party data, using captured context to generate insights and trigger system actions while ensuring users retain real-time control over their own data and influence over AI behavior.

In one aspect, the invention provides a first-party AI engine for enhanced data privacy and accuracy that operates primarily on first-party data provided directly by the user without reliance on inferred signals or third-party enrichment, ensuring data provenance, reducing compliance risk, improving model trustworthiness, and maintaining a persistent link between user-supplied context and AI engine behavior.

### DEFINITIONS

As used in this specification and the appended claims, the following terms have the meanings set forth below. These definitions are intended to provide clarity and precision for the purposes of this patent application and are not intended to limit the ordinary and customary meaning of these terms in contexts outside of this disclosure.

AI Agent. A software module that utilizes artificial intelligence techniques to perform designated functions within the system, including natural language processing, decision making, orchestration, and data analysis. Each AI agent operates within a scoped context defined by its assigned phase or function within the customer journey. AI agents include, without limitation, the Smart Conversation Discovery AI Agent, phase-specific journey creation agents, phase-specific editing agents, predictive scoring agents, deployment planning agents, and the top-level orchestration agent. Each AI agent receives input from one or more sources (user input, upstream agent outputs, session state), generates output constrained by a predetermined output schema, and operates under deterministic control logic defined by the orchestration engine or a governing finite state machine.

Call-to-Action (CTA). A system-generated directive that serves dual purposes within the system. As a user interface element, a CTA presents an interactive prompt directing a user to perform a specified action, such as advancing to a subsequent journey phase, involving additional stakeholders, or initiating solution scoping. As an orchestration mechanism, a CTA encodes an action type and associated parameters that trigger backend state transitions, database mutations, or inter-agent coordination events. CTAs are dynamically generated based on real-time journey context, stage outputs, and session state. A CTA replaces the function of hardcoded workflow transitions by providing declarative, context-sensitive orchestration directives.

Execution Instance (also referred to, as legacy synonyms retained for consistency with the underlying provisional application, as “Customer Journey” and “Multi-Phase Execution Flow”). A single instantiated sequence of stage-scoped interactions processed by the system, comprising a plurality of sequential stages each associated with a stage-specific AI agent, and maintaining its own session state, shared contextual state, and progression indicators. The term “execution instance” is the primary term used throughout this specification and the appended claims. The terms “customer journey” and “multi-phase execution flow” are synonymous with “execution instance” and are used only where retained from the underlying provisional application or for continuity with deployed software identifiers. No limitation to any particular domain of interaction, to any particular class of participants, or to any particular commercial context is intended by the use of the term “customer” in the legacy synonym; the execution instance may represent any multi-phase interaction sequence in which a plurality of participant entities contribute structured inputs to a shared contextual state over time. An execution template (equivalently, a “journey template”) defines the stage structure and initial content of an execution instance; an execution instance is created by cloning an execution template and assigning new unique identifiers while preserving template row identifier mappings.

Session State Data Structure. A data structure maintained for each conversation session within a customer journey, comprising at minimum a current question identifier, a current section index, a set of answered question identifiers, a set of skipped question identifiers, and a completion status indicator. The session state data structure serves as the authoritative record of conversational progress and governs FSM state transitions. Updates to the session state data structure occur only upon successful validation of AI agent output against the predetermined output schema.

Dynamic Customer Journey Orchestration; Dynamic Execution Flow Orchestration. A method and system for managing the multi-phase execution flow that adapts in real time to input, contextual data, and system state, replacing static workflows and rigid decision trees with AI-agent-driven interactions governed by the orchestration engine. AI agents, operating under FSM governance and schema-based output validation, guide the execution flow, complete tasks, extract insights, make predictions, and serve as interactive interfaces. Dynamic orchestration includes context-aware delegation to specialized AI agents, enabling modular execution across sequential stages without manual workflow construction, predefined logic trees, or centralized conditional branching.

Finite State Machine (FSM); State-Controlled Progression Mechanism. A computational model comprising a finite set of states, transitions between states, and actions associated with each state and transition. In the context of this invention, the FSM defines the allowable conversational states for the Smart Conversation Discovery AI Agent, including answer-and-advance, re-engage, revise-and-reengage, and skip. Each state represents a distinct phase of interaction. Transitions between states are governed by predetermined transition rules based on user input, session state, and the result of output schema validation. The FSM is one illustrative embodiment of a broader category referred to herein as a “state-controlled progression mechanism.” A state-controlled progression mechanism, as used herein, includes any deterministic structure that defines a set of allowable session states and a set of transition rules governing movement between said states, including without limitation a finite state machine, a rule-based progression engine, a state chart, a workflow graph, a decision table driving state transitions, or any equivalent deterministic state-transition structure. The FSM enforces deterministic conversational flow by prohibiting state advancement unless a valid structured update or explicit skip command is present; more generally, the state-controlled progression mechanism prohibits state advancement unless a candidate response satisfies the output schema validation. The large language model or other probabilistic generative model operates as a scoped interface at each state, generating candidate responses within the constraints defined by the current state. The state-controlled progression mechanism does not permit the probabilistic generative model to determine session progression autonomously.

Hierarchical AI Agent. An organizational structure for AI agents wherein a top-level supervisory AI agent delegates portions of an overall task to subordinate, phase-specific AI agents. The supervisory agent generates a global blueprint or plan and coordinates execution across the subordinate agents. Each subordinate agent operates autonomously within its scoped context while contributing structured outputs to a shared contextual state. This hierarchy enables division of cognitive and functional load, ensures that each segment of the customer journey is handled by the most contextually appropriate agent, and supports distributed, parallel orchestration. Hierarchical AI agent structures are used in journey creation, journey editing, and deployment planning within the system.

Large Language Model (LLM); Probabilistic Generative Model. A deep neural network model trained on extensive corpora of text data, capable of generating or analyzing human language. Within the system, the LLM produces candidate responses to scoped prompts issued under FSM control or orchestration engine direction. LLM outputs are treated as candidates subject to validation against a predetermined output schema before being accepted for state transitions or downstream processing. The term “large language model” as used throughout this specification and the appended claims is an illustrative example of a broader class of probabilistic generative models; the invention applies equivalently to other generative or probabilistic models whose output is non-deterministic with respect to a given input, including without limitation transformer-based neural networks, generative neural models, probabilistic sequence models, statistical language models, and any other model architecture that produces a candidate output subject to validation as described herein. The system architecture decouples agent behavior from any specific model implementation, enabling pluggable integration of different generative models. No per-tenant or per-user fine-tuning of the model is required. Specialization is achieved through structured prompt engineering, contextual chaining, and schema-constrained output generation.

Orchestration Engine. The central module within the system responsible for coordinating interactions among AI agents, managing state transitions, synchronizing multi-stakeholder inputs, and ensuring overall system coherence throughout the customer journey. The orchestration engine instantiates journey instances from templates, delegates responsibility to stage-specific AI agents, monitors stage completion indicators, generates CTA directives, routes CTA directives to consumer action handlers via a dispatch table, maintains the shared contextual state, and generates pruned contexts for downstream agents. The orchestration engine operates without predefined workflow logic, instead relying on dynamic evaluation of journey context, agent outputs, and CTA-encoded directives to determine the sequence and timing of orchestration events.

Output Schema. A structured data format, such as JSON, that defines the required elements, content fields, and metadata of an AI agent's output. The output schema comprises at minimum a message field containing natural language content and a structured update field encoding one or more data modification instructions. The use of JSON is illustrative and not limiting; the output schema of the invention may be expressed in any machine-parseable structured data format, including without limitation JSON, XML, YAML, Protocol Buffers, Apache Avro, BSON, MessagePack, or any other binary-encoded or text-encoded structured format capable of representing a message field and a structured update field with defined types. The output schema serves as the validation contract between the probabilistic generative model and the FSM or orchestration engine. A candidate response must satisfy the output schema before a state transition is permitted. The output schema ensures that each agent's output is both interpretable by users and machine-parseable by downstream modules within the orchestration engine.

Predictive Engine. A module that analyzes extracted features from journey interaction data and computes a score forecasting journey outcomes, including deal progression, journey success probability, and timeline estimates. The predictive engine computes the score using a formula comprising a base success rate, calibrated feature weights, normalized feature value offsets, and scaling factors. The predictive engine outputs an explainable result comprising the numerical score and a weighted breakdown of contributing features ranked by magnitude of contribution. Feature weights are derived through computation of empirical lift values and LLM-assisted calibration. The predictive engine operates on first-party data collected directly from user interactions within the system.

Validation Module. A subsystem responsible for verifying that the output generated by a large language model complies with the predetermined machine-parseable output schema. The validation module compares each candidate response against the output schema, verifying the presence and format of required fields including the message field and the structured update field. For questions associated with predefined selectable options, the validation module further verifies that selected values match valid options. Only upon successful validation are state transitions or further processing permitted according to the FSM or orchestration logic. If validation fails, the candidate response is rejected, the current conversational state is maintained, and a re-engagement prompt is generated. The validation module maintains a per-turn failure counter for each session; upon validation failure, the counter is incremented and the re-engagement prompt incorporates a reference to the specific output schema field that failed validation. Upon the failure counter exceeding a configured retry threshold, the current state is frozen pending explicit user intervention, and no further LLM invocations are performed for the current turn until the freeze is cleared. The freeze mechanism prevents runaway LLM invocations and bounds the worst-case behavior of the system when the LLM repeatedly produces non-compliant output.

Consumer Action Handler. A software component configured to receive validated structured update instructions from an AI agent's output and execute corresponding database mutations. Consumer action handlers are organized in a dispatch table indexed by action type identifier. Upon successful output schema validation, the structured update field is dispatched to the appropriate consumer action handler, which executes the database update within an atomic transaction with row-level locking. Consumer action handlers ensure that AI agent outputs produce deterministic, auditable state changes in the system's persistent data store.

Dispatch Table. A data structure that maps action type identifiers to corresponding consumer action handlers. When a validated CTA directive or structured update instruction is produced by an AI agent, the orchestration engine uses the dispatch table to route the instruction to the appropriate consumer action handler for execution. The dispatch table enables declarative routing of orchestration events without hardcoded conditional logic, supporting extensibility and modular addition of new action types.

Template Row Identifier. A unique identifier assigned to each element of a journey instance that maps the instance element back to its corresponding element in the originating journey template. Template row identifiers enable lineage tracking between template definitions and their instantiated journey instances. This mapping supports template improvement based on instance outcomes, duration optimization through retrieval of historical execution data from instances sharing a common template lineage, and statistical analysis across journey instances derived from the same template.

Directed Acyclic Graph (DAG). A graph data structure comprising nodes and directed edges with no cycles, used within the deployment planning system to represent deployment tasks and their dependency relationships. Each node represents a deployment task with an associated duration, and each directed edge represents a dependency constraint requiring one task to complete before another begins. The system executes a topological sort on the DAG to determine valid task execution order, computes a critical path through the DAG based on task durations, and propagates planned dates through the DAG using workday-aware scheduling that accounts for weekends, holidays, and configured working hours. Hierarchical duration aggregation allows parent task durations to be computed from child task durations, with changes in any child task triggering re-propagation through all affected ancestor and descendant nodes.

Contextual Pruning. A mechanism for generating structured, high-signal context handoffs between AI agents by removing irrelevant dialogue, stripping rich text markup, and distilling key user inputs, decisions, and outcomes from upstream interactions. Contextual pruning produces a reduced data representation containing only decision-relevant information for the downstream AI agent, scoped to the relevant stage of the customer journey. This mechanism reduces prompt size, improves downstream agent performance, and ensures seamless, stage-aware coordination. Contextual pruning is performed by a data export utility configured to receive parameters specifying stage isolation, data minification, markup removal, and option inclusion criteria.

Empirical Lift Value. A computed metric representing the change in journey success rate when a specific feature value exceeds a defined threshold, relative to a base success rate computed across all completed journey instances associated with a given template. Empirical lift values are computed for each feature in the predictive scoring feature set and are used as inputs for weight calibration. The empirical lift value quantifies the marginal predictive contribution of each feature, enabling both automated weight assignment and explainable scoring outputs.

### BRIEF DESCRIPTION OF THE DRAWINGS

FIG. 1 is a block diagram illustrating the system architecture overview of the agentic AI system 100, including the orchestration engine 110, FSM module 120, LLM interface 130, validation module 140, session state module 150, CTA generator 160, dispatch table 170, template library 180, predictive engine 190, DAG scheduler 200, pruning module 210, health monitor 220, multi-stakeholder coordination module 230, agent hierarchy module 240, marketplace module 250, template evolution engine 260, duration optimizer 270, knowledge asset processor 280, permission controller 290, audit module 300, and WebSocket communication layer 310.

FIG. 2 is a block diagram illustrating the FSM-driven smart conversation discovery agent 1200, including the input interface 1210, FSM controller 1220, conversational states (answer-and-advance 1222, re-engage 1224, revise-and-reengage 1226, skip 1228), LLM 1230, scoped prompt generator 1232, output schema validator 1240, session state 1250, and consumer action handler 1260.

FIG. 3 is a flow diagram illustrating the CTA-based orchestration flow, including journey context 400, CTA generator 160, CTA directive 410, user interface element 412, orchestration trigger 414, dispatch table 170, consumer action handlers 420, database 430, WebSocket broadcast 440, and connected clients 450.

FIG. 4 is a block diagram illustrating the hierarchical journey agent flow, including the top-level orchestration agent 500, discovery agent 510, scope agent 520, commit agent 530, deploy agent 540, meetings agent 550, journey template 560, supervisory editor agent 570, and phase-specific editor agents 580.

FIG. 5 is a state diagram illustrating the smart conversation FSM states and transitions, including start state 600, question presented 610, answer-and-advance 620, re-engage 630, revise-and-reengage 640, skip 650, section complete 660, all complete 670, and revisit skipped 680.

FIG. 6 is a data flow diagram illustrating the contextual pruning process, including raw journey data 700, export utility 210, stage isolation parameter 712, minification parameter 714, RTE removal parameter 716, option inclusion parameter 718, pruned context 720, message history 730, slice threshold 732, truncation notice 734, system prompt 736, and downstream agent 740.

FIG. 7 is a block diagram illustrating the deployment DAG scheduling system, including deploy module nodes 800, dependency edges 810, topological sort 820, critical path 830, duration propagator 840, schedule propagator 850, workday rules 860, and planned dates output 870.

FIG. 8 is a flow diagram illustrating the predictive scoring pipeline, including completed journeys 900, feature extractor 910, feature vectors 920, base success rate 930, empirical lifts 940, LLM weight calibrator 950, cached weights 960, target journey 970, score calculator 980, and explainable output 990.

FIG. 9 is a block diagram illustrating the template lifecycle and lineage tracking, including template creation 1000, AI journey creator 1010, template library 180, framework categories 1020, published template 1030, clone operation 1040, journey instance 1050, template row ID mapping 1060, instance outcomes 1070, and template improvement 1080.

### DETAILED DESCRIPTION OF THE INVENTION

The following detailed description sets forth specific embodiments of the invention with reference to the accompanying drawings. The description is not intended to limit the scope of the invention but rather to enable those skilled in the art to practice the invention. Throughout this description, reference numerals are used consistently to identify system components, and like numerals refer to like components across all described embodiments.

The invention is implemented as a computer-implemented system (also referred to as “system 100”) comprising one or more processors and one or more non-transitory computer-readable memory devices storing instructions that, when executed by the processor or processors, cause the system to perform the operations described in this specification and recited in the appended claims. Each component described herein is realized as a software module, a data structure, a database table, a computational algorithm, or a combination thereof, executing on conventional computing hardware. No specialized or custom hardware is required. The computer-implemented system 100 executes on one or more physical or virtual servers, which may be deployed on-premises, in a public or private cloud, or in a hybrid configuration; client devices communicate with the system 100 through standard network protocols.

### System Architecture Overview

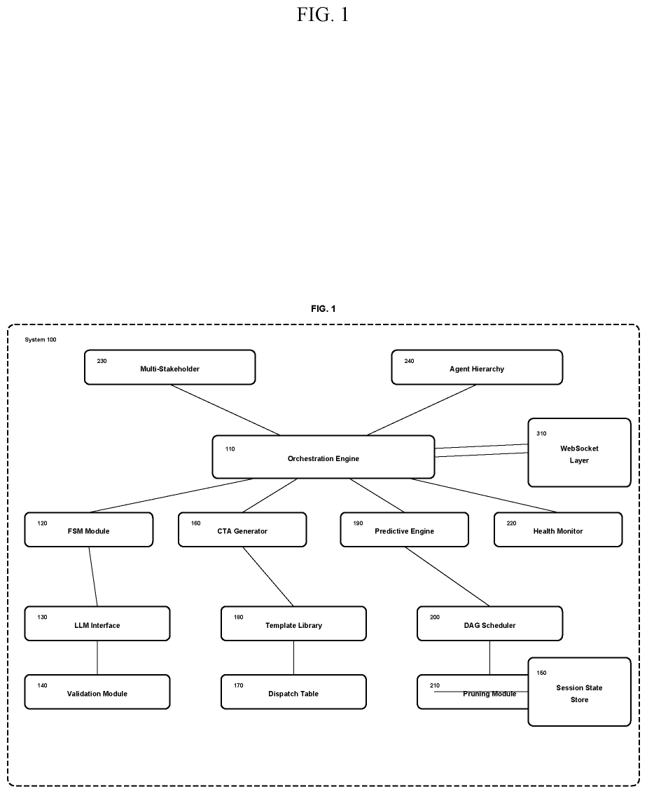

Referring now to the drawings, FIG. 1 illustrates the overall architecture of the agentic AI system 100 for dynamic customer journey orchestration. The system 100 comprises an orchestration engine 110, a finite state machine (FSM) module 120, a large language model (LLM) interface 130, a validation module 140, a session state module 150, a CTA generator 160, a dispatch table 170, a template library 180, a predictive engine 190, a DAG scheduler 200, a pruning module 210, a health monitor 220, a multi-stakeholder coordination module 230, an agent hierarchy module 240, a marketplace module 250, a template evolution engine 260, a duration optimizer 270, a knowledge asset processor 280, a permission controller 290, an audit module 300, and a WebSocket communication layer 310.

The system 100 operates on first-party data exclusively. The core control architecture of the system 100 converts non-deterministic LLM generation into deterministic, auditable system behavior through three coordinated mechanisms: (i) the FSM module 120 governs state transitions using a finite set of defined states, (ii) the validation module 140 gates state transitions on successful validation of each LLM candidate response against a predetermined machine-parseable output schema, rejecting non-conforming outputs and maintaining the current state, and (iii) the dispatch table 170 binds each validated structured output to a deterministic consumer action handler that executes an atomic database mutation with row-level locking, such that a single validated output produces both a state transition and a persistent data change as one indivisible operation. The orchestration engine 110 coordinates multiple specialized AI agents across sequential stages of the execution flow through a shared contextual state reduced for each downstream agent by the pruning module 210 using deterministic inclusion rules.

### Component 0: Schema-Gated State Transition Mechanism (Validation Module 140, FSM Module 120, Dispatch Table 170)

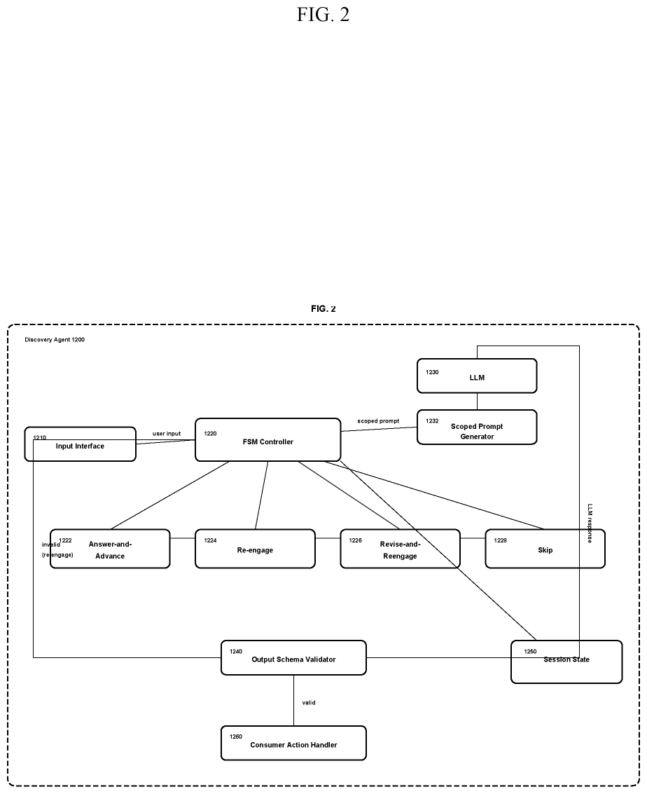

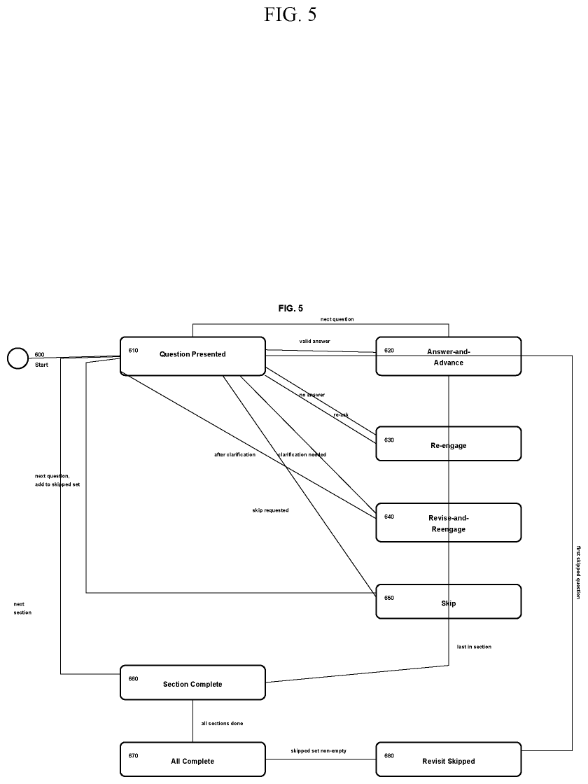

The schema-gated state transition mechanism is the core control architecture of the system 100 and is depicted at element-level in FIG. 2 and FIG. 5. The mechanism governs every LLM invocation within the system 100. The mechanism operates as a single indivisible sequence of steps; any interruption or failure at any step returns the system to the current state without side effects.

### Invocation

Upon entering a state requiring LLM inference, the scoped prompt generator constructs a prompt comprising (i) the output schema specification, (ii) the task description, (iii) the FSM state transition rules encoded in natural language, and (iv) the current session context. The prompt is transmitted to the LLM interface 130, which returns a candidate response.

### Validation

The validation module 140 parses the candidate response as JSON and executes the following verification steps in order:
1. Parse structural integrity. If the response is not syntactically valid JSON, validation fails with a “structural_integrity” failure code.
2. Verify presence of required fields. The response must contain a message field and a structured update field. If either is missing, validation fails with a “missing_required_field” failure code referencing the missing field name.
3. Verify types of required fields. The message field must be a string and the structured update field must be a JSON object. If types are mismatched, validation fails with a “type_mismatch” failure code referencing the field name and expected type.
4. Verify structured update content. The structured update field must contain an action type identifier present in the dispatch table 170 and a parameter set conforming to the schema for the identified action. If the action type is unknown or the parameter set is malformed, validation fails with an “invalid_structured_update” failure code.
5. Verify constrained-choice semantics. For a current question associated with a predefined set of selectable options, the selected value in the structured update field must match one of the predefined options. If the selected value is not present in the option set, validation fails with an “invalid_option_selection” failure code referencing the invalid value.

### Successful Validation

Upon successful validation, the system performs the following operations as a single atomic transaction under row-level locks on affected database records:
1. Update the session state data structure according to the FSM transition rules for the current state.
2. Dispatch the structured update field to the consumer action handler selected from the dispatch table 170 based on the action type identifier. The consumer action handler executes the corresponding database mutation.
3. Broadcast the resulting state update to all connected clients via the WebSocket communication layer 310.
4. Transition the FSM to the subsequent state.

The atomic transaction ensures that the state transition, the database mutation, and the broadcast occur together or not at all. A failure at any substep rolls back all substeps.

### Validation Failure With Differentiated Per-Code Handling

Upon validation failure, the system performs the following operations, differentiated by the specific failure code produced during validation:
1. Reject the candidate response. No database mutation is executed. No state transition is performed. The session state data structure is not modified. Any partial preparatory state held within the in-progress atomic transaction is discarded through transaction rollback.
2. Increment a per-turn failure counter for the current session. The per-turn failure counter decays by one after each successful turn, such that long-running sessions do not accumulate failures from unrelated earlier turns toward the freeze threshold.
3. Select a failure-code-specific handling path:
   (a) structural_integrity failure. When the candidate response is not syntactically valid JSON, the LLM has failed to produce machine-parseable output of any form. Retry is unlikely to recover. The system directly freezes the current state, records the frozen state in the session state data structure with a timestamp and the structural_integrity failure code, and suspends further LLM invocations for the current turn until the freeze is cleared by an operator. This handling path avoids wasteful retry cycles against an LLM producing unparseable output.
   (b) missing_required_field failure. The JSON structure is valid but a required field (message field or structured update field) is absent. The system generates a re-engagement prompt that explicitly names the missing field and requests its inclusion. The per-turn failure counter is incremented; the state is not frozen unless the counter exceeds the retry threshold.
   (c) type_mismatch failure. A required field is present but its type does not conform to the schema (for example, the message field is not a string, or the structured update field is not a JSON object). The system generates a re-engagement prompt that names the mismatched field and states the expected type. The per-turn failure counter is incremented.
   (d) invalid_structured_update failure. The structured update field is well-typed but contains an action type identifier absent from the dispatch table 170, or a parameter set that does not conform to the schema for the identified action. The system generates a re-engagement prompt that lists the valid action type identifiers enumerated in the dispatch table 170 and, when applicable, the required parameter schema for the intended action. The per-turn failure counter is incremented.
   (e) invalid_option_selection failure. For a current question associated with a predefined set of selectable options, the value selected by the LLM does not match any predefined option. The system generates a re-engagement prompt that lists the valid predefined options verbatim from current_question_pulldown_options. The per-turn failure counter is incremented.
4. For failure codes (b) through (e), upon the per-turn failure counter exceeding a configured retry threshold, the system freezes the current state in the same manner as (a), recording the frozen state with the terminal failure code and a failure summary for audit purposes. The freeze mechanism bounds the worst-case behavior of the system against an LLM that repeatedly produces non-conforming output of the same type.

### Nature of the Gating Mechanism Versus Conventional Validation

The mechanism described in this Component is distinct from conventional input validation, from conventional output quality assurance, and from routine data-correctness checking. The distinction is material to understanding the technical improvement provided by the invention and is therefore set forth here expressly.

What the validation module does not do. The validation module 140 does not verify semantic correctness of content produced by the LLM. The validation module does not determine whether a stated value is factually accurate, whether a date is in a valid range, whether a numerical value is plausible, whether a name resolves to a real entity, or whether a selected option is a wise choice among valid alternatives. The validation module does not filter for truth, accuracy, reasonableness, or quality of content. A factually implausible answer carried in a schema-conforming structured output passes validation; a factually correct answer carried in a malformed structure fails validation.

What the validation module does. The validation module verifies structural conformance of the LLM candidate response to a predetermined machine-parseable output schema. The validation module treats the LLM output as data passing across the boundary between a probabilistic generation component and a deterministic downstream pipeline. The validation module's sole function is to ensure that data crossing this boundary is in the exact structural form the downstream pipeline can consume. The mechanism is therefore not a content filter but an execution gate.

Conventional input validation, distinguished. Conventional input validation rejects user-entered data at a form field before that data is stored. Its purpose is data-quality assurance. The user sees an error and corrects the input. The validation occurs against user-generated content. In contrast, the mechanism described herein validates LLM-generated output, not user input. Its purpose is not data-quality assurance but execution gating. The LLM does not see an error in the human sense; the system rejects the output, maintains its current state, and issues a new generation request through the re-engagement prompt.

Output quality assurance, distinguished. Output quality assurance systems evaluate language model output against criteria such as relevance, safety, factuality, or style. These systems produce a quality score or pass/fail decision that the surrounding application may use at its discretion to accept or reject output. The surrounding application retains freedom to transition state irrespective of the quality evaluation. In contrast, the mechanism described herein does not evaluate quality. The mechanism imposes a hard gate on state progression: if structural conformance is not satisfied, no state transition is permitted. The surrounding application has no discretion to bypass the gate.

### Technical Improvement Provided by the Gating Mechanism

The mechanism described in this Component provides a technical improvement in the functioning of the computer system. The improvement is directed to the technical problem of integrating a probabilistic generation component (the large language model) with a deterministic downstream execution pipeline (the finite state machine, dispatch table, consumer action handlers, and persistent data store) without permitting the probabilistic component's non-determinism to propagate into the deterministic pipeline. The mechanism solves this technical problem by imposing a structural-conformance gate at the boundary between the two components and by binding successful gate passage to a single atomic operation that encompasses state transition, database mutation, and client notification.

The improvement is not the predictable combination of known elements. A finite state machine operating alone transitions between defined states based on defined inputs; it does not address probabilistic input sources. A large language model operating alone produces probabilistic output; it does not constrain its own output to a predetermined schema. A dispatch table operating alone routes well-formed instructions; it does not distinguish well-formed from malformed instructions. An atomic database transaction operating alone ensures consistency of persistent state changes; it does not gate upstream control flow. The asserted improvement arises from the specific coordinated operation of these components in the arrangement described herein: structural-conformance gating at the output boundary of the probabilistic component, with successful gate passage bound to a single indivisible atomic operation comprising state transition, dispatch, database mutation, and client notification. The result of this coordinated operation is deterministic, auditable system behavior driven by probabilistic LLM output—a result that would not have been predictable from the individual components considered according to their established functions.

### Exclusivity of the Execution Mechanism

The schema-gated state transition mechanism is the sole pathway through which state change and database mutation occur within the system 100. This exclusivity is a structural property of the system, not merely a functional effect:
1. No session state data structure field is modified outside the atomic transaction triggered by a successful validation of an LLM candidate response against the output schema. Session state fields are accessible only through the validation pathway; no direct write interface to session state exists outside this pathway.
2. No consumer action handler is invoked outside the dispatch operation triggered by a successful validation. Consumer action handlers are accessed only through the dispatch table 170 based on an action type identifier present in a validated structured update field; no direct invocation of a consumer action handler by any other module is permitted by the system architecture.
3. No database mutation on records tracked by the session state data structure occurs outside the atomic transactions executed by consumer action handlers invoked via the dispatch table. Direct database writes outside the dispatch pathway are not part of the claimed system.
4. No real-time client broadcast of state updates occurs outside the atomic transactions described above. The WebSocket communication layer 310 transmits multi_update_array messages only as a consequence of a successful consumer action handler execution within the atomic transaction.

The exclusivity property is enforced by the architecture rather than asserted as an effect. A candidate response that fails validation cannot invoke a consumer action handler because the dispatch operation is conditioned on successful validation. A request that bypasses the validation module cannot produce a state change because the consumer action handlers are not reachable outside the dispatch pathway. The system therefore admits state change and data mutation only through the schema-gated pathway, and the pathway admits these effects only for validated, schema-conforming outputs.

### Atomic Binding of Transition and Persistence as Structural Invariant

The unification of FSM state transition with database mutation and client broadcast within a single atomic transaction is a structural invariant of the system, not an implementation detail. The binding is enforced by the transaction boundary as follows:
1. The transaction begins before the validation module completes its check. Session state read operations performed during validation occur within the same transaction scope as the subsequent write operations, preventing read/write tearing under concurrent access.
2. Upon successful validation, within the same transaction, the system acquires row-level locks via select_for_update() on all database records to be modified by the consumer action handler, updates the session state data structure according to the FSM transition rules, executes the consumer action handler's database mutation, and enqueues the multi_update_array broadcast message for transmission.
3. The transaction commits only after all of the foregoing operations complete successfully. Any failure at any step causes the transaction to roll back, discarding the session state update, the database mutation, the acquired locks, and the queued broadcast. The FSM is restored to its pre-transaction state through the rollback.
4. The transaction therefore commits the state transition, the database mutation, and the broadcast as a single indivisible unit, or commits none of them. No partial state-in which the FSM has advanced but the database mutation has not occurred, or in which the database mutation has occurred but the FSM has not advanced-is reachable under this architecture.

The structural invariant is material because it eliminates a class of errors that arise in systems where state transition and persistence are treated as independent operations. In such systems, a transition may commit while a subsequent persistence operation fails, producing an FSM state that references non-existent data; conversely, persistence may complete while the transition fails, leaving the FSM unaware of a committed data change. The atomic binding described herein eliminates both failure modes by construction.

### System Behavior Under Stress

The system 100 exhibits defined, bounded behavior under stress conditions. Stress conditions and the corresponding system responses are enumerated below:
1. Repeated validation failure by the LLM for a single turn. The per-turn failure counter increments on each failure. Upon exceeding the configured retry threshold, the current state is frozen, further LLM invocations for the current turn are suspended, and the frozen-state condition is recorded in the session state data structure with the terminal failure code and a timestamp. Human operator action is required to clear the freeze. The system does not enter an unbounded retry loop under any condition.
2. Absence of user input for an extended period. The execution state monitoring subsystem (described in Component 14) tracks elapsed time since the last activity timestamp. Upon exceeding the configured inactivity threshold, the monitoring subsystem emits a structured intervention signal to the top-level orchestration agent. The signal triggers generation of a re-engagement CTA directed to the applicable participant entity. The FSM state is preserved during the inactivity period.
3. Concurrent modification attempt by multiple participant entities on the same record. The row-level locks acquired via select_for_update() during consumer action handler execution serialize concurrent writes. A second concurrent transaction attempting to write the same record blocks until the first transaction commits or rolls back. Deadlock detection within the database engine resolves any circular lock dependencies by aborting one of the contending transactions, which is retried at the application level with backoff.
4. Database transaction commit failure. Any failure during the atomic transaction-including lock acquisition failure, constraint violation, storage layer error, or explicit abort-causes the transaction to roll back. The FSM state, the session state data structure, and the persistent data store are all returned to their pre-transaction values. The candidate response that triggered the failed transaction is discarded. The current turn is recorded as having failed validation with the applicable failure code, and the per-turn failure counter is incremented.
5. LLM unavailability or transport failure. When the LLM interface 130 is unable to obtain a candidate response due to network failure, rate limiting, or service unavailability, the FSM remains in the current state. A transport-failure event is logged. No per-turn failure counter increment occurs because no candidate response was produced; transport failures are distinct from schema validation failures. Retry behavior for transport failures is governed by a separate transport-layer retry policy with its own bounded retry count and backoff.
6. Conflicting updates arriving through concurrent dispatch operations. Where two or more validated outputs target the same record within overlapping time intervals, serialization through row-level locking ensures that one dispatch operation completes before the other begins. The second operation observes the state produced by the first and proceeds or aborts according to the consumer action handler's consistency checks against the now-current state.

The enumerated stress conditions and responses provide real system behavior under operational failure modes. The behavior is bounded in all cases: the system does not enter unbounded retry loops, does not produce partial state updates, and does not admit state change or data mutation outside the schema-gated pathway.

### Instruction Completeness Requirement

The validated structured output of the probabilistic generative model constitutes a complete and self-contained instruction set for system execution. The output is not an advisory signal, a partial recommendation, a hint, or a suggestion combined with subsequent system-supplied logic. The output carries all fields required by the predetermined machine-parseable output schema for the action type it specifies; any output missing one or more required fields is rejected by the validation module, does not trigger a state transition, does not trigger a database mutation, and does not trigger a client broadcast. The system does not fill in missing fields from defaults, does not infer intended values from context, and does not complete partial outputs from historical data. If the generative model does not produce a schema-complete output, no system effect occurs. This instruction-completeness requirement distinguishes the invention from systems that treat generative-model output as a partial input subsequently combined with system-supplied logic, heuristics, or rule-based completions.

### No Implicit Inference

The deterministic downstream pipeline does not perform implicit inference on candidate model outputs. The pipeline does not reason about ambiguous output, does not choose among competing interpretations of an output, and does not substitute default behavior for missing content. The pipeline executes exactly the content of the validated structured update field, in the form specified by the output schema, and nothing else. Where output content is ambiguous, incomplete, or non-conforming, the output is rejected and the generative model is re-prompted within the current state rather than interpreted by the pipeline.

### Idempotency and Repeatability

The execution semantics of the system are idempotent and repeatable with respect to the validated structured update field. A given validated structured update field applied to a given session state produces a defined, repeatable state transition and database mutation; repeated execution of the same validated structured update field against the same initial state produces the same final state, without compounding effects and without introducing inconsistent state transitions. The deterministic consumer action handler for each action type is a pure function of its validated input and the pre-execution state. This idempotency property combines with the atomic-binding invariant to provide repeatable system behavior under retries and under concurrent-execution edge cases.

### Atomicity as an Architectural Property

The atomicity described in this Component is not limited to database-level atomicity. The atomic operation executed within the schema-gated pathway is atomic across three levels simultaneously: (i) the session state data structure (the FSM-level state), (ii) the persistent data store (the database-level state), and (iii) the outbound client-notification channel (the WebSocket broadcast queue). All three are committed or rolled back together. The invention's atomic-binding invariant therefore operates at an architectural level rather than at a single-storage-subsystem level; partial execution across any subset of these three levels is prohibited by construction. This architectural atomicity is materially different from, and stronger than, conventional database-level ACID guarantees that apply only to persistent-storage writes.

### Flexibility of the Exclusivity Property

The exclusivity property described in the preceding sections, which provides that the validated structured output of the generative model is the sole mechanism by which the session state data structure and persistent data tracked by the session state data structure are modified, is expressed as a strict property in the appended claims. In other implementations contemplated by this disclosure, the exclusivity property may be practiced as a primary or dominant execution-path property rather than as a strict exclusivity property. In such implementations, the schema-gated pathway is the only path by which the specific categories of state and data tracked by the session state data structure are modified during session execution, while out-of-band administrative operations such as backup restoration, schema migration, or break-glass operator interventions may modify persistent storage through privileged pathways operating outside normal session execution. These out-of-band pathways do not participate in session execution and do not produce state transitions within the session state data structure during normal operation. This disclosure contemplates the strict exclusivity property, the primary-pathway property, and the enforced-execution-path property as alternative embodiments of the invention.

### System Improvements Enabled by the Architecture

The schema-gated state transition mechanism provides measurable technical improvements over conventional systems that combine generative models with downstream execution. The improvements include: (i) reduction of inconsistent state transitions to zero within the session boundary, because partial execution is prohibited by construction; (ii) prevention of execution of malformed instructions, because non-conforming outputs are rejected before they can reach the consumer action handlers; (iii) enforcement of deterministic system evolution, because every state change is the consequence of a validated, schema-conforming output; (iv) bounded worst-case behavior under repeated generative-model failure, because the non-progressing state halts further attempts after a configured retry threshold; (v) auditable linkage between every persistent-state change and a specific validated generative-model output, enabling forensic reconstruction of system behavior; and (vi) portability of the deterministic pipeline across different generative-model implementations, because the schema and gating requirements are invariant with respect to the specific model used. These improvements are technical in nature and are attributable to the specific architecture described herein; they do not arise from any component of the architecture considered in isolation.

### Applicability Beyond Conversational Systems

The invention is not limited to conversational systems or to systems in which the probabilistic generative model produces natural-language output as its primary function. The invention applies to any system in which a probabilistic generative component produces candidate outputs that drive downstream deterministic execution. Illustrative applications beyond conversational interfaces include code-generation systems in which the generative model produces executable code fragments subject to schema-conformance validation before deployment, automation systems in which the generative model produces control signals subject to validation before issuance to actuators, planning systems in which the generative model produces task sequences subject to validation before commitment to a plan, and data-transformation systems in which the generative model produces extraction or transformation directives subject to validation before execution against a data store. In each such application, the same schema-gated pathway, exclusivity requirement, and atomic binding described herein apply without modification to the architecture.

### Purpose of the Gating Mechanism

The schema-gated state transition mechanism produces two non-obvious technical behaviors that are not produced by any single prior-art component, and that are not predictable from the routine combination of those components:

First, the mechanism converts non-deterministic LLM generation into deterministic, auditable system behavior. Every state change and every database mutation in the system 100 is the consequence of a validated, schema-conforming LLM output. An LLM output that fails validation cannot produce any state change or database mutation. This guarantee holds regardless of which LLM is in use, what prompt is transmitted, or how the LLM was trained.

Second, the mechanism unifies state progression and persistence through a single validated output. A validated structured output is simultaneously the trigger for an FSM state transition and the source of a database mutation, executed within a single atomic transaction with row-level locking. The same output produces both effects through a single indivisible operation. Systems that validate output without binding validation to deterministic backend effects still require ad hoc routing logic to propagate outputs into state. Systems that route outputs to backend effects without gating on schema validation still permit malformed outputs to reach persistent state. Systems that gate and route but do not combine the two under a single atomic transaction still admit inconsistency between state transition and data persistence under concurrent access. Only the combination described herein produces the deterministic, auditable behavior described.

### Component 1: Execution Flow Orchestration (Orchestration Engine 110)

The orchestration engine 110 serves as the central coordination module for the system 100. The orchestration engine 110 manages the lifecycle of journey instances, delegates responsibilities to stage-specific AI agents, monitors stage completion indicators, generates CTA directives via the CTA generator 160, routes CTA directives to consumer action handlers via the dispatch table 170, maintains the shared contextual state, and generates pruned contexts for downstream agents via the pruning module 210.

Each journey instance is represented as a journey object (cNode) with a universally unique identifier (UUID) serving as its primary key. The journey object maintains a hierarchical data structure. At the top level, the journey object stores global metadata including the journey name, creation timestamp, owning organization, associated template reference, result state, and configuration flags. Beneath the journey object, a plurality of stage objects (cNodeStage) represent the sequential phases of the customer engagement. Each stage object functions as a navigational tab within the user interface and contains references to the feature models specific to that stage.

The system 100 supports five typical stage types: Discovery, Scope, Commit, Deploy, and Meetings. However, the architecture imposes no fixed constraint on the number or type of stages. Stages may repeat within a single journey instance via a tabStructureCount parameter, enabling configurations such as multiple discovery phases for complex engagements or multiple deployment phases for phased rollouts.

The orchestration engine 110 instantiates journey instances from templates stored in the template library 180. During instantiation, the engine 110 clones the template structure, assigns new unique identifiers to each element, and preserves template row identifier mappings (template_rowId) that link each instance element back to its originating template element. This lineage tracking enables the template evolution engine 260 to trace instance outcomes back to specific template elements for continuous improvement.

The orchestration engine 110 operates without predefined workflow logic. Instead of encoding fixed sequences of steps, the engine 110 evaluates the current journey context, stage completion indicators, agent outputs, and CTA-encoded directives to determine the sequence and timing of orchestration events dynamically. This approach eliminates the combinatorial complexity of maintaining static workflow definitions across multiple customer segments, product configurations, and engagement scenarios.

### Component 2: Agentic Flow (agent Hierarchy Module 240)

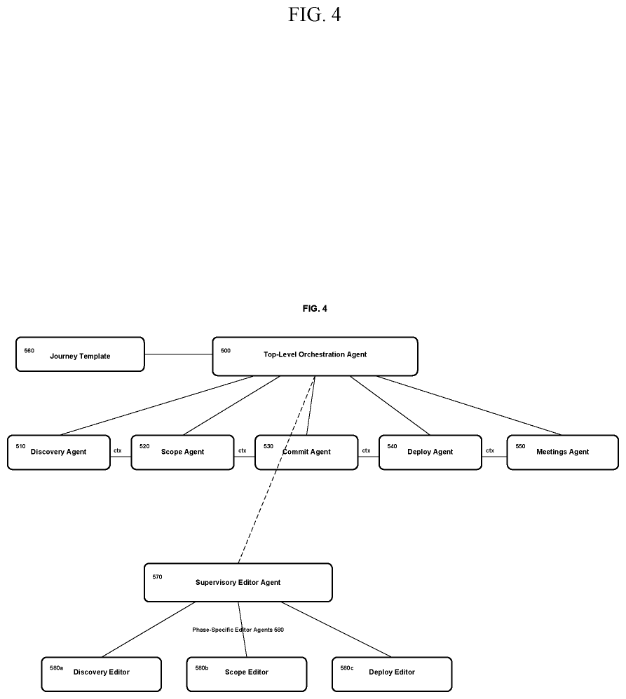

Referring to FIG. 4, the agent hierarchy module 240 defines the organizational structure and execution paradigm for all AI agents within the system 100. The module 240 implements a base class hierarchy rooted in a CustomerNodeGPT base class, which provides common functionality including LLM communication, prompt construction, output parsing, and error handling. A CustomerNodeStageAgentGPT subclass extends the base class with stage-aware context injection, enabling agents to receive contextual data scoped to their assigned stage.

Specific agent implementations extend the stage agent class to perform specialized functions within each journey phase. This hierarchical structure ensures consistent behavior across all agents while enabling functional specialization through inheritance and configuration.

The system 100 supports three distinct agent execution paradigms:

One-time task agents execute a single function and return a result. These agents receive a prompt, generate a response, validate the output, and terminate. Journey creation agents and certain editing agents operate in this paradigm.

Chat agents maintain conversational state across multiple turns. These agents preserve message history, track session state through the session state module 150, and operate under FSM governance via the FSM module 120. The Smart Conversation Discovery AI Agent operates in this paradigm.

Custom agents implement application-specific state machines beyond the standard FSM model. These agents define their own state transitions and validation logic while still operating within the orchestration engine 110 framework.

Each agent operates within a scoped context derived from the journey instance. Upstream agent outputs flow into downstream agents through the shared contextual state, enabling fluid, asynchronous, and parallel orchestration without centralized control logic. The orchestration engine 110 coordinates agent activation and deactivation based on stage transitions and CTA directives, but does not dictate the internal behavior of any agent.

### Component 3: Hierarchical Template Generation (Agent Hierarchy Module 240, Template Library 180)

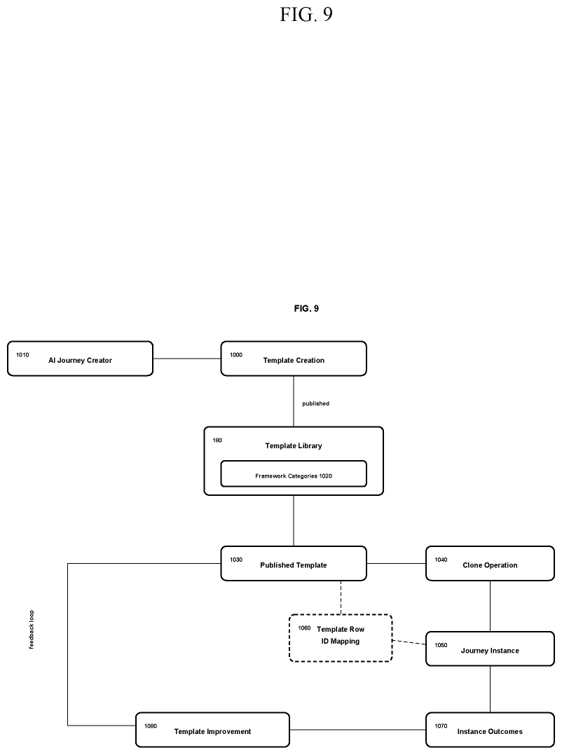

Referring to FIG. 4 and FIG. 9, the system 100 provides a hierarchical AI-agent-driven template generation subsystem. A top-level template creator AI agent receives a set of structured inputs comprising: a first entity description identifying the initiating entity, a second entity description identifying a counterparty entity, and an offering description identifying a subject of the execution flow. Optionally, one or more knowledge assets may be attached and processed by the knowledge asset processor 280, including documents in DOCX, XLSX, or PDF format.

From these inputs, the top-level creator agent generates a global template blueprint comprising all stages, each populated with phase-appropriate content. The creation process operates through hierarchical delegation: the top-level agent produces the overall structure, then delegates to phase-specific subordinate agents that refine and populate each stage with detailed content including discovery questions, scope modules, deployment tasks, meeting agendas, and commitment milestones.

The system 100 supports mid-review gates during template generation. After the top-level agent generates the initial stage flow, the system may pause for approval before proceeding with detailed population of each stage. This gate ensures that an operator retains control over the structural direction of the template before the system invests computational resources in detailed content generation.

The generated template blueprint is stored in the template library 180 or instantiated directly as an execution instance. All generated elements receive template row identifiers enabling subsequent lineage tracking.

### Component 4: Template Distribution Subsystem (Marketplace Module 250)

The marketplace module 250 provides a template distribution subsystem that accepts template submissions from external creators, executes conformance validation on each submission, records provenance and licensing metadata, and integrates approved templates into the template library 180. The module 250 manages template discovery, submission, review, and distribution through the following data structures and processes.

A templateFramework model stores framework definitions comprising a framework name, a textual description, and an associated image. Each framework organizes templates into thematic categories aligned with industry verticals, engagement types, or functional domains.

A templateFrameworkTag model stores tags within each framework, enabling granular categorization and search filtering. Templates are associated with frameworks and tags through foreign key relationships: a libraryFramework field links a template to its parent framework, and a libraryFrameworkTag field links a template to its specific tag within that framework.

A templatePublishedInCnodeLibrary boolean flag on each template controls visibility in the shared library. When set to true, the template is accessible to authorized users for browsing, preview, and instantiation.

The marketplace module 250 includes an external submission interface through which external template creators submit templates for review. A conformance validation module evaluates submitted templates for structural schema conformance and compatibility with the system 100 architecture. An integration module incorporates approved templates into the template library 180 through template row identifier mapping. A licensing module records template provenance metadata including creator identifier, submission timestamp, approval status, and applicable licensing terms.

### Component 5: Hierarchical Template Refinement (Agent Hierarchy Module 240)

The system 100 provides a hierarchical AI-agent-driven template refinement subsystem that operates after initial template generation. A supervisory editing AI agent analyzes the existing template structure to detect refinement opportunities, including incomplete sections, suboptimal question sequencing, missing deployment dependencies, and misaligned scope modules.

The supervisory editing agent delegates refinement tasks to phase-specific editing agents. Each phase-specific editing agent operates within its scoped context and executes non-destructive modifications that preserve the structural integrity of the existing journey. Non-destructive modification means that editing operations add, reorder, or refine content without deleting or overwriting user-provided data unless explicitly instructed.

The CTA generator 160 produces context-sensitive editing CTAs that route users to the appropriate phase-specific editing agent. These CTAs appear in the user interface as actionable prompts (e.g., “Refine discovery questions” or “Add deployment dependencies”) and simultaneously encode orchestration directives that activate the corresponding editing agent with the appropriate scoped context.

### Component 6: Self-Improving Template Engine (Template Evolution Engine 260)

Referring to FIG. 9, the template evolution engine 260 operates as follows.

The template evolution engine 260 enables journey templates to evolve over time based on historical AI interactions, user behavior, and outcome data. The engine 260 operates through the template row identifier system: every element in every journey instance (discovery questions, scope modules, deployment tasks, meeting items, commitment milestones) carries a template_rowId field that maps back to the originating template element.

A cNodeCopyTemplateContent class manages the transfer of content from template to instance during instantiation. This class maintains a templateScopeModuleIdToJourneyId mapping that tracks the relationship between template scope modules and their instantiated counterparts, enabling bidirectional traceability.

The template evolution engine 260 analyzes interaction patterns across all instances derived from a given template. Analyzed patterns include:
Skipped questions: Questions frequently skipped across multiple instances indicate low relevance or poor phrasing, triggering a CTA to the template owner suggesting removal or revision.
Common responses: Questions that consistently receive the same answer across instances may indicate that the answer should be pre-populated or that the question should be replaced with a confirmation prompt.
Drop-off points: Stages or sections where user engagement consistently declines indicate structural friction, triggering recommendations for content reordering or simplification.

Instance outcomes (success, not success, on hold) are traced back to template elements through the template row identifier lineage. This tracing enables the engine 260 to identify which template elements correlate with positive outcomes and which correlate with negative outcomes, producing data-driven template optimization recommendations surfaced via AI agent-generated CTAs.

### Component 7: CTA-Based Transitions-Unified Command Model Across UI and Backend (CTA Generator 160, Dispatch Table 170)

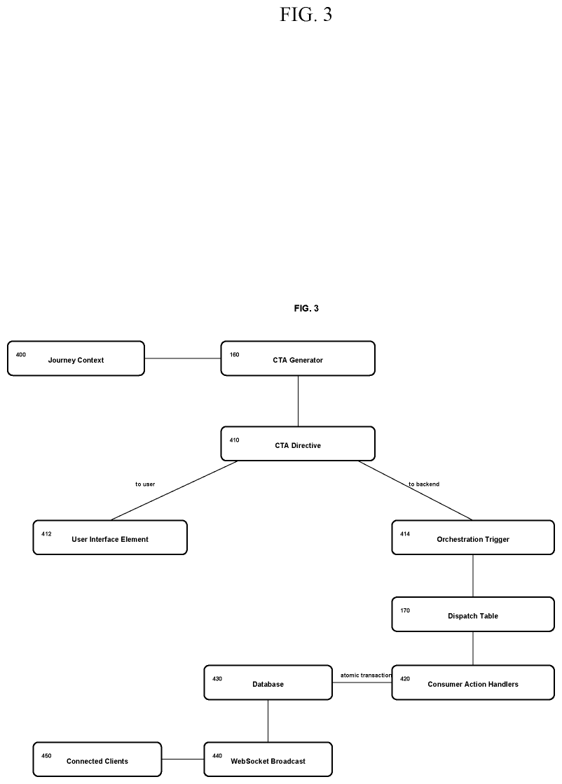

Referring to FIG. 3, the CTA-based transition system operates as follows.

The CTA is a unified command object that simultaneously expresses a user-facing interactive prompt and a backend execution directive. A single CTA object, and not two separate objects, produces both effects. The properties of this unified command model are as follows:
1. Single structured object. Each CTA is a structured directive object comprising an action type identifier and an associated parameter set. There is no separate “UI CTA” and “backend CTA”; the object used to render the user interface element is identically the object used to invoke backend execution.
2. Routing exclusively through the dispatch table. Backend execution triggered by a CTA occurs only through the dispatch table 170. No direct invocation of a consumer action handler by any component other than the dispatch table is permitted in the architecture. The CTA's action type identifier selects the consumer action handler; the dispatch table enforces the routing.
3. No separate mapping layer. The rendering of the user interface element and the routing of the backend effect use the same action type identifier. No intermediate mapping layer translates UI events into backend commands; the CTA's action type is the command identifier in both contexts.
4. No branching logic between UI and backend. Conditional logic that would select between multiple backend effects for a single UI affordance does not exist in the architecture. A CTA with a given action type identifier always routes to the single consumer action handler registered for that identifier in the dispatch table.

The unified command model eliminates the impedance mismatch between user interface components and backend handlers that arises in conventional architectures, where UI events must be translated through an ad hoc mapping layer into backend commands and where branching logic is required to handle per-context variations. In the present invention, the CTA is the command in both contexts.

The CTA generator 160 produces Call-to-Action directives that serve dual purposes within the system 100: as interactive user interface elements and as structured orchestration directives. Each CTA encodes an action type identifier and associated parameters that the orchestration engine 110 uses to trigger backend state transitions, database mutations, or inter-agent coordination events.

The dispatch table 170 implements an AiConsumerActions module that maps action type identifiers to consumer action handlers. The dispatch table 170 supports eleven or more action handlers, each responsible for a specific category of database mutation:
1. discovery_table_update: Handles updates to discovery table structure including row additions, reordering, and metadata modifications.
2. discovery_answer_field_update: Handles updates to individual discovery question answer fields, validated against the discovery data model.
3. scope_answer_field_update: Handles updates to scope question answer fields within scope modules.
4. meetings_table_update: Handles structural updates to the meetings table including meeting creation, deletion, and reordering.
5. meetings_object_update: Handles updates to individual meeting object properties including scheduling data, attendee lists, and agenda items.
6. proposed_scope_table_update: Handles updates to proposed scope items during the evaluation phase.
7. scope_questions_table_update: Handles updates to scope question definitions within scope modules.
8. goals_update: Handles updates to journey-level and stage-level goal definitions.
9. deploy_table_update: Handles structural updates to the deployment plan including task additions, dependency modifications, and reordering.
10. deploy_content_update: Handles updates to deployment task content fields including descriptions, instructions, and resource assignments.
11. commit_table_update: Handles updates to commitment milestone items including status changes and completion tracking.

Each consumer action handler validates the incoming structured update against the corresponding database model. Row-level locking is enforced using select_for_update() to prevent race conditions in concurrent access scenarios. All database mutations execute within a transaction. atomic() context to ensure ACID (Atomicity, Consistency, Isolation, Durability) compliance.

The dispatch table 170 performs duplicate ID filtering to prevent redundant updates when multiple CTA directives target the same record within a single interaction cycle.

Upon successful execution, each consumer action handler broadcasts the state update to all connected clients via the WebSocket communication layer 310 as multi_update_array messages. This broadcast ensures that all stakeholders viewing the journey instance receive real-time updates reflecting the latest state changes.

### Component 8: Smart Conversation Discovery AI Agent (FSM Module 120, Session State Module 150, Validation Module 140, LLM Interface 130)

Referring to FIG. 2 and FIG. 5, the Smart Conversation Discovery AI Agent 1200 is described in detail. FIG. 2 depicts the internal organization of the discovery agent 1200, comprising an input interface 1210, an FSM controller 1220, four conversational state handlers (answer-and-advance 1222, re-engage 1224, revise-and-reengage 1226, and skip 1228), an LLM 1230, a scoped prompt generator 1232, an output schema validator 1240, a session state 1250, and a consumer action handler 1260. The FSM controller 1220 of FIG. 2 is implemented by the FSM module 120 of FIG. 1; the LLM 1230 of FIG. 2 is provided by the LLM interface 130 of FIG. 1; the output schema validator 1240 of FIG. 2 is implemented by the validation module 140 of FIG. 1; the session state 1250 of FIG. 2 is maintained by the session state module 150 of FIG. 1; and the consumer action handler 1260 of FIG. 2 is invoked through the dispatch table 170 of FIG. 1.

The Smart Conversation Discovery AI Agent 1200 is the primary conversational interface within the discovery phase of the customer journey. This agent operates under deterministic control of the FSM module 120 (realized as FSM controller 1220 in FIG. 2) and maintains conversational state through the session state module 150 (realized as session state 1250 in FIG. 2). User input is received through input interface 1210 and processed by FSM controller 1220, which dispatches to one of four state handlers (1222, 1224, 1226, or 1228) based on the user's response classification.

### Session State Data Structure

The session state module 150 maintains a session state dictionary for each active conversation session. The dictionary comprises the following fields:
current_question_id: A unique identifier referencing the question currently being presented to the user. This identifier maps to a specific row in the discovery table associated with the journey instance.
current_section_index: An integer index indicating the user's position within the ordered sequence of discovery sections. Sections group related questions into logical clusters.
skipped_questions_set: A set data structure containing the identifiers of all questions the user has explicitly skipped during the conversation.
answered_questions_set: A set data structure containing the identifiers of all questions the user has answered with validated responses.
has_completed_all: A boolean flag set to true when the user has answered or explicitly addressed every question in the discovery table, excluding skipped questions.
has_completed_all_with_skips: A boolean flag set to true when the user has answered all previously skipped questions during a revisit cycle, indicating full completion including revisited skips.
current_question_is_pulldown: A boolean flag indicating whether the current question is associated with a predefined set of selectable options (dropdown-type question).
current_question_pulldown_options: When current_question_is_pulldown is true, this field contains the list of valid selectable options for the current question.

### Finite State Machine States and Transitions

The FSM module 120 defines four primary response states for the discovery agent, depicted in FIG. 2 as state handlers 1222, 1224, 1226, and 1228:
(A) Answer-and-Advance State 1222. The user provides a substantive answer to the current question. The validation module 140 (output schema validator 1240 in FIG. 2) verifies that the candidate response contains a valid structured update field encoding the answer. For dropdown-type questions, the validation module 140 further verifies that the selected option matches one of the values in current_question_pulldown_options. Upon successful validation, the session state module 150 adds the current question identifier to the answered_questions_set, advances current_question_id to the next question in sequence, updates current_section_index if a section boundary is crossed, and permits the FSM to transition to the next conversational turn.
(B) Re-engage State 1224. The user does not provide an answer to the current question. The user's response may be tangential, off-topic, or non-responsive. The FSM maintains the current state and the LLM interface 130 (LLM 1230 in FIG. 2) generates a re-engagement prompt that re-asks the question with added nuance, additional context, or alternative phrasing designed to elicit a substantive response. The current_question_id does not change. No state transition occurs.
(C) Revise-and-Reengage State 1226. The user asks a clarifying question about the current question. The LLM interface 130 generates a response that answers the user's clarifying question and then re-asks the original question. The FSM maintains the current state. No state transition occurs until a substantive answer is provided and validated.
(D) Skip State 1228. The user explicitly requests to skip the current question or expresses persistent confusion after re-engagement attempts. The session state module 150 adds the current question identifier to the skipped_questions_set, advances current_question_id to the next question, and permits the FSM to transition forward.

### Dropdown Validation

For questions where current_question_is_pulldown is true, the validation module 140 performs an additional validation step. If the LLM interface 130 generates a candidate response that selects an option not present in current_question_pulldown_options, the validation module 140 rejects the response and triggers a re-engagement prompt that explicitly lists the valid options. This mechanism prevents the LLM from hallucinating invalid selections for constrained-choice questions.

### Dual Completion Modes

The system 100 supports two distinct completion modes:

All-answered completion. When every question in the discovery table has been either answered (present in answered_questions_set) or skipped (present in skipped_questions_set), the has_completed_all flag is set to true. If skipped_questions_set is non-empty, the system generates a CTA offering the user the option to revisit skipped questions.

All-answered-including-revisited-skips completion. When the user elects to revisit skipped questions, the FSM re-enters at the first question in skipped_questions_set. The LLM interface 130 intercepts a GO_BACK_TO_SKIPPED_QUESTIONS control string from the LLM output to trigger this revisit cycle. Upon answering all previously skipped questions, the has_completed_all_with_skips flag is set to true, indicating comprehensive completion.

### Progress Milestones

The system 100 generates progress milestone notifications at predetermined question counts: 1, 5, 10, 20, 30, and 50 questions answered. These milestones serve as positive reinforcement within the conversational flow and provide the user with a sense of progression through the discovery process.

### Message History Management

To manage LLM context window utilization and computational cost, the system 100 implements message history slicing. The LLM interface 130 transmits only the last eight messages (configurable via SLICE_MSG_HISTORY_FOR_API_AT parameter) from the conversation history to the LLM. To compensate for the truncated history, the system injects the full session context, including all answered questions, all skipped questions, current section progress, and the complete discovery table structure, into the system prompt that accompanies each scoped prompt. A truncation notice is injected into the message history: “History truncated, you have full context in system prompt.”

### LLM System Prompt Structure

The scoped prompt generator 1232, shown in FIG. 2, constructs the system prompt transmitted to the LLM interface 130 for the discovery agent. The system prompt comprises four sections:
1. JSON format rules: Specifies the exact structure of the expected output schema, including field names, data types, required fields, and formatting constraints. This section ensures the LLM generates machine-parseable output conforming to the validation module 140 requirements.
2. Task description: Defines the agent's role, objective, and behavioral constraints. This section instructs the LLM to act as a conversational discovery agent that collects information through natural dialogue while producing structured outputs.
3. Conversational flow rules: Encodes the FSM state transition logic in natural language, instructing the LLM on how to handle each of the four response states (answer-and-advance, re-engage, revise-and-reengage, skip) and when to generate progress milestone notifications. 4. Context scope: Provides the full session context including the discovery table structure, answered questions with their responses, skipped questions, current section progress, and any relevant upstream context from other journey phases.

### Component 9: Deployment Planning (DAG Scheduler 200, Duration Optimizer 270)

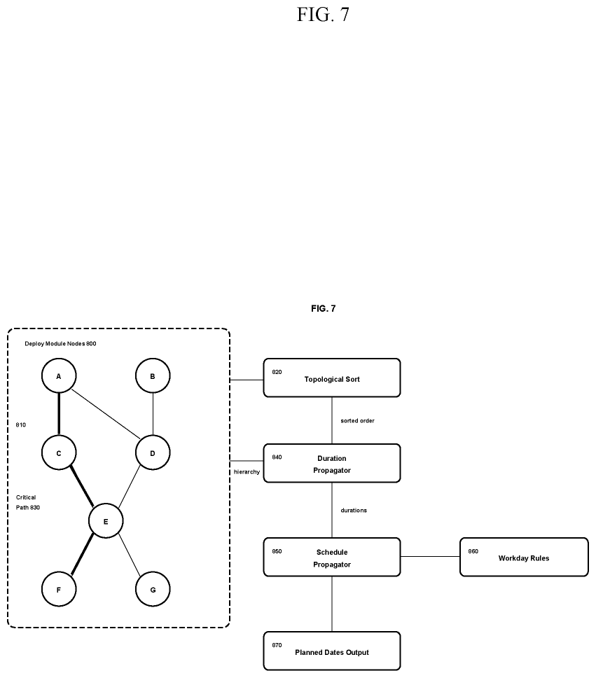

Referring to FIG. 7, the deployment planning system is described in detail.

The DAG scheduler 200 operates downstream of, and as an integrated component of, the schema-gated execution architecture described in Component 0. The DAG scheduler 200 accepts as input to a deployment plan only structured outputs that have passed schema validation by the validation module 140 and have been persisted through the dispatch table 170 as described in Component 0. Data that did not pass schema validation never enters the DAG. The scheduling operations therefore operate on a bounded set of structurally conformant inputs and produce deterministic scheduling outputs for a given DAG configuration.

The DAG scheduler 200 implements a deployment planning system that automatically generates deployment plans comprising timelines and structured deployment tasks. The plans are generated from schema-validated structured outputs produced by upstream stage-specific AI agents during earlier stages of the execution instance (discovery stage outputs, scope stage outputs, commit stage outputs). These upstream outputs reach the DAG scheduler only through the schema-gated pathway defined in Component 0 and therefore carry the deterministic guarantees established by that pathway.

### DAG-Based Scheduling

The DAG scheduler 200 represents deployment tasks as nodes in a directed acyclic graph (DAG) with directed edges representing dependency constraints. Each node stores a task identifier, task name, estimated duration, planned start date, planned end date, actual start date, actual end date, and references to parent and child nodes.

A DurationPropagator module traverses the DAG to compute planned dates based on task durations and dependency constraints. The propagation algorithm operates as follows:
1. Execute a topological sort on the DAG using Kahn's algorithm. Kahn's algorithm initializes an in-degree counter for each node equal to a count of incoming dependency edges.
Nodes with an in-degree counter of zero are enqueued into a processing queue. The algorithm then iteratively dequeues a node from the processing queue, appends the dequeued node to an ordered output sequence, decrements the in-degree counter of each successor node of the dequeued node, and enqueues each successor node whose in-degree counter has reached zero into the processing queue. The algorithm terminates when the processing queue is empty. The resulting ordered output sequence represents a valid task execution order respecting all dependency constraints.
2. For each node in topological order, compute the planned start date as the latest planned end date among all predecessor nodes. If the node has no predecessors, the planned start date defaults to the project start date.
3. Compute the planned end date by advancing the planned start date by the task duration using workday-aware scheduling.
4. Identify the critical path as the longest path through the DAG measured by cumulative duration. The critical path determines the minimum total project duration; any delay to a task on the critical path delays the entire project.

### Workday-Aware Scheduling

A DeploySchedulingOptions configuration object controls scheduling behavior. The configuration specifies: a list of holiday dates to exclude from working day calculations, weekend day indicators (Saturday and Sunday by default), working hour windows (start time and end time), and timezone settings. The DurationPropagator consults this configuration when advancing dates, skipping non-working days and holidays to produce realistic schedules.

### Hierarchical Duration Aggregation

The DAG scheduler 200 supports hierarchical task structures where parent tasks contain child tasks. Parent task durations are computed from child task durations using one of two aggregation modes: maximum (the parent duration equals the longest child, representing parallel execution) or sum (the parent duration equals the total of all children, representing sequential execution). When any child task duration changes, the change propagates upward through all ancestor nodes and downward through all dependent descendant nodes.

### Backtracking

When upstream constraints change (e.g., a predecessor task duration increases or a new dependency is added), the DAG scheduler 200 performs backtracking to re-propagate dates through all affected nodes. Backtracking ensures that the deployment plan remains consistent with the current dependency graph and duration estimates at all times.

### Concurrency Control

The DAG scheduler 200 enforces atomic locking using select_for_update() on all task records during propagation operations. This row-level locking prevents race conditions when multiple users or automated processes attempt to modify the deployment plan concurrently. All propagation operations execute within transaction. atomic() contexts.

### Auto-Scheduling

An auto-scheduling flag on each project controls whether the DAG scheduler 200 automatically re-propagates dates when any task property changes. When enabled, any modification to a task duration, dependency, or constraint triggers immediate re-propagation through the entire DAG. When disabled, the user must manually trigger re-propagation.

### Component 10: State-Aware Planning

The deployment planning subsystem within the DAG scheduler 200 generates plans using structured state data from one or more prior customer journey phases. Rather than operating in isolation, the deployment plan incorporates outputs from discovery, evaluation (scope), and onboarding (commit) phases.

Structured outputs from the discovery phase include customer requirements, constraints, timeline preferences, and readiness indicators. Structured outputs from the scope phase include agreed deliverables, resource allocations, and acceptance criteria. Structured outputs from the commit phase include signed-off milestones and contractual obligations.

The pruning module 210 prepares these upstream outputs for consumption by the deployment planning agents, stripping irrelevant conversational dialogue and retaining only decision-relevant structured data. This state-aware approach enables adaptive planning based on the customer's evolving state rather than static rule sets.

### Component 11: Learning-Based Plan Optimization (Duration Optimizer 270)

The duration optimizer 270 computes optimized task duration estimates from historical evidence collected across previously completed journey instances. The optimizer 270 operates through the following process:
1. Historical duration extraction. The optimizer 270 queries the database for all deployment tasks from completed journey instances that share a common template lineage (identified by template_rowId). For each matching task, the optimizer 270 extracts the actual_start date and actual_end date to compute the actual duration.
2. Matching strategies. The optimizer 270 supports two matching strategies for identifying relevant historical data:
TEMPLATE_MATCH: Retrieves durations from tasks sharing the same template_rowId, representing tasks derived from the same template element. This strategy provides the strongest lineage match.
EXACT_NAME: Retrieves durations from tasks with identical module names, regardless of template lineage. This strategy provides broader historical coverage when template lineage data is sparse.
3. Statistical methods. The optimizer 270 computes optimized durations using a configurable statistical method selected from:
AVERAGE: The arithmetic mean of historical durations.
MINIMUM: The shortest historical duration, representing best-case performance.
MAXIMUM: The longest historical duration, representing worst-case performance.
P25: The 25th percentile of historical durations, representing an optimistic but realistic estimate.
P75: The 75th percentile of historical durations, representing a conservative estimate.
4. Application. The computed optimized durations replace the default estimated durations in the target deployment plan. The DAG scheduler 200 then re-propagates dates through the DAG using the optimized durations.

### Component 12: Multi-Tenant Adaptive Planning

The system 100 operates in a multi-tenant architecture where each tenant maintains its own set of journey instances, templates, and configuration settings. The duration optimizer 270 and the predictive engine 190 scope all computations to the requesting tenant's data, ensuring data isolation.

Features extracted by the predictive engine 190 are normalized using population-level minimum and maximum values computed across the tenant's completed journey instances. This normalization ensures that feature values are comparable across journey instances with different absolute scales.

To handle class imbalance in tenants with disproportionate success/failure ratios, the system 100 applies SMOTE (Synthetic Minority Oversampling Technique) oversampling during model calibration. SMOTE generates synthetic feature vectors for the minority class, improving the predictive engine's ability to distinguish between success and failure outcomes in imbalanced datasets.

### Component 13: Concurrent Multi-Agent State Synchronization (Multi-Stakeholder Coordination Module 230, Permission Controller 290)

The multi-stakeholder coordination module 230 enables a plurality of participant entities operating at distinct permission levels to contribute structured writes to a shared contextual state associated with a single execution instance. Asynchronous writes from multiple participant entities are serialized through row-level locking to prevent state divergence, and are propagated to all connected clients through a real-time communication channel. The permission controller 290 enforces access control through three hierarchical permission checkers:
1. OrgPermissionChecker: Validates permissions at the organization level. Organization-level roles include coordinator, superviewer, supereditor, superadmin, and member. Each role grants a specific set of capabilities across all journey instances owned by the organization.
2. GuestPermissionChecker: Validates permissions for external stakeholders (guests) invited to participate in the journey. Guest-level roles include admin, editor, and viewer. Guest permissions are scoped to the specific journey instance to which the guest has been invited.
3. cNodePermissionChecker: Validates permissions at the individual journey instance level, enabling fine-grained access control that may differ from organization-level defaults.

### Access Link Types

The system 100 supports two types of access links for inviting stakeholders:
Standing links: Permanent access links that remain valid indefinitely. Standing links are appropriate for ongoing stakeholders such as account managers and customer success representatives.
One-time links: Temporary access links with a seven-day expiry period. One-time links are appropriate for transient stakeholders such as evaluation participants, subject matter experts, or approval signatories.

### Domain-Based Access Restrictions

The permission controller 290 supports domain-based access restrictions through a guestAllowedDomains configuration on each journey instance. When configured, only users with email addresses matching one of the allowed domains may accept guest invitations. This mechanism prevents unauthorized access when access links are shared beyond the intended audience.

### Asynchronous Input Aggregation

The multi-stakeholder coordination module 230 aggregates asynchronous inputs from multiple stakeholders into the unified shared contextual state maintained by the orchestration engine 110. Each stakeholder may interact with the journey instance at different times, through different devices, and at different cadences. The coordination module 230 timestamps all inputs and merges them into the shared state, ensuring that all agents and all stakeholders operate on a consistent, current view of the journey.

### Component 14: Execution State Monitoring (Health Monitor 220)

The health monitor 220 provides an execution state monitoring subsystem that continuously evaluates stage completion indicators, activity timestamps, and per-role interaction counts against configured thresholds and emits structured intervention signals to the orchestration engine 110 upon threshold breach. The intervention signals route through the CTA generator 160 to produce AI-agent-driven recommendations. The health monitor 220 continuously tracks the following metrics:

### Stage Completion Tracking

For each stage within a journey instance, the health monitor 220 maintains three counters:
numLineItems: The total number of actionable items (questions, tasks, milestones) within the stage.
numCompleteLineItems: The number of items that have been completed or answered.
numExcludedLineItems: The number of items that have been excluded or marked not applicable.

Stage completion percentage is computed as numCompleteLineItems divided by (numLineItems minus numExcludedLineItems), expressed as a percentage.

### Activity Monitoring

The health monitor 220 tracks engagement recency and frequency through:
Days since last activity: Computed from the most recent timestamp of any host or guest interaction with the journey instance.
Host views and edits: Count of view sessions and edit actions performed by the host organization's users.
Guest views and edits: Count of view sessions and edit actions performed by guest stakeholders.

### Result States

Each journey instance and each stage within a journey instance maintains a result state selected from:
Active: The journey or stage is in progress with ongoing engagement.
Success: The journey or stage has reached its intended outcome.
Not Success: The journey or stage has been closed without achieving its intended outcome.
On Hold: The journey or stage has been paused, with the expectation of future resumption.

### Daily Aggregation

An InstanceSummary model performs daily aggregation of interaction data across all journey instances. This aggregation produces summary statistics including total views, total edits, host activity counts, guest activity counts, and stage completion snapshots. These aggregated metrics feed into the predictive engine 190 as features and into the Success Hub interface as dashboard indicators.

### AI Agent-Driven Interventions

When the health monitor 220 detects indicators of stagnation (extended periods without activity, incomplete stage transitions, declining engagement frequency), it generates intervention signals. These signals trigger AI agent-driven recommendations including suggested follow-up actions, re-engagement CTAs, and escalation notifications to journey owners.

### Component 15: Empirical-Lifts Predictive Scoring Engine (Predictive Engine 190)

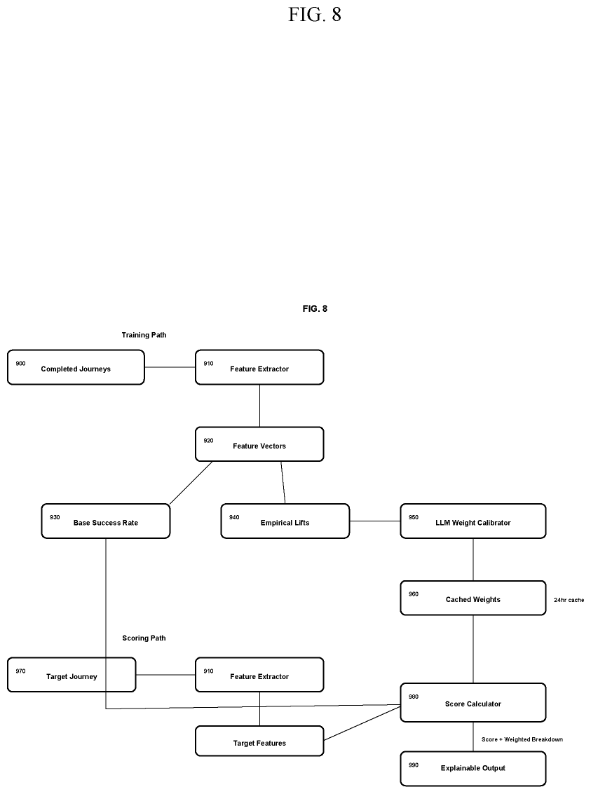

Referring to FIG. 8, the predictive scoring pipeline is described in detail.

The predictive engine 190 implements an AI-based predictive scoring and outcome forecasting system. The engine 190 uses an InstantPredictor module that computes predictions using an empirical lifts methodology.

### Base Success Rate

The predictive engine 190 computes a base success rate from population statistics across all completed journey instances associated with a given template within the requesting tenant. The base success rate represents the proportion of completed journeys that achieved a “Success” result state, providing the prior probability against which individual journey features are evaluated.

### Feature Extraction

A JourneyFeatureExtractor module extracts seventy or more normalized features from each journey instance. Features include:
Stage completion percentages: Proportion of completed items within each stage.
Time in stage: Duration spent in each stage, measured in working days.
Questions answered: Count and proportion of discovery questions answered versus skipped.
Scope acceptance: Whether scope modules have been accepted or are pending.
Meetings scheduled: Count of meetings scheduled, completed, and cancelled.
owner_success_rate: Historical success rate of the journey owner across their portfolio of journey instances.
Interaction frequency metrics: Cadence of host and guest activity.
Temporal progression indicators: Days elapsed, days remaining relative to target dates, velocity of stage completion.

Empirical Lifts

For each feature, the predictive engine 190 computes an empirical lift value. The empirical lift represents the change in success rate observed when a specific feature value exceeds a defined threshold, relative to the base success rate. Features that correlate strongly with positive outcomes produce positive lift values; features that correlate with negative outcomes produce negative lift values.

### Weight Calibration

The predictive engine 190 transmits the set of features and their corresponding empirical lift values to the LLM interface 130, configured to generate calibrated weight assignments for each feature. The LLM evaluates the relative importance and interaction effects among features and assigns a numerical weight to each. These weight assignments are cached for twenty-four hours, after which the system recomputes them to incorporate newly completed journey instances. The LLM calibrates weights once per cycle rather than per prediction, ensuring computational efficiency.

### Prediction Formula

For a target journey instance, the predictive engine 190 computes the predictive score using the following formula:

prediction=base+sum(weight_i (normalized_i−0.5) 0.1)
where:
base is the base success rate computed from the population.
weight_i is the calibrated weight for the i-th feature.
normalized_i is the normalized value of the i-th feature for the target journey instance, scaled to the range [0, 1] using population-level minimum and maximum values.
The offset of 0.5 centers the normalized value around the population mean.
The scaling factor of 0.1 controls the magnitude of each feature's contribution relative to the base rate.

### Prediction Modes

The predictive engine 190 supports two prediction modes:
Classification mode: Predicts whether the journey will achieve a “Success” or “Not Success” outcome. The prediction score is interpreted as a probability, clamped to the range [0, 1].
Regression mode: Predicts a continuous value such as expected timeline to completion or expected revenue value. The prediction score is not clamped and represents a point estimate on the target variable's scale.

### Diagnostics

The predictive engine 190 generates diagnostic metrics for model evaluation:
Accuracy: Proportion of correct predictions across the evaluated dataset.
Precision: Proportion of true positive predictions among all positive predictions.
Recall: Proportion of true positive predictions among all actual positive instances.
F1 Score: Harmonic mean of precision and recall.
AUC (Area Under the Curve): Area under the receiver operating characteristic curve, measuring the model's ability to discriminate between success and failure outcomes across all classification thresholds.
Confusion matrix: Tabulation of true positives, true negatives, false positives, and false negatives.
SHAP importance: Feature importance rankings computed using SHAP (SHapley Additive exPlanations) values, providing interpretable attribution of each feature's contribution to individual predictions.

### Trust Grading

The predictive engine 190 assigns a trust grade to each predictive model based on three dimensions:
Performance grade (A/B/C): Based on accuracy, precision, recall, and AUC metrics against predetermined thresholds.
Overfitting grade (A/B/C): Based on the gap between training performance and holdout performance, indicating generalization capability.
Data quantity grade (A/B/C): Based on the number of completed journey instances available for calibration, with higher counts producing higher grades.

### Success Driver Analysis

The predictive engine 190 identifies overutilized and underutilized success drivers. Overutilized drivers are features with high positive lift values that are already present in most successful journeys, indicating well-established best practices. Underutilized drivers are features with high positive lift values that are present in only a minority of successful journeys, indicating optimization opportunities where increased attention could improve outcomes.

### Component 16: Agentic Business Process Architecture

The system 100 implements an agentic business process architecture that enables flexible, adaptive AI-driven decision-making without static logic trees or predefined workflows. AI agents within the system 100 respond dynamically to real-time data and contextual signals through prompt-driven inference, schema validation, and orchestrated agent transitions.

In this architecture, the behavior of each agent is determined by:
1. Prompt-driven inference: The LLM interface 130 receives a structured prompt encoding the current context, task definition, and output format requirements. The LLM generates a candidate response through inference rather than by following a predetermined decision tree.
2. Schema validation: The validation module 140 verifies each candidate response against the predetermined output schema, ensuring that the response contains valid structured updates before any state transition is permitted.
3. Orchestrated transitions: The orchestration engine 110 manages transitions between agents based on CTA directives, stage completion indicators, and shared contextual state, rather than through hardcoded routing logic.

This architecture eliminates the need for manual workflow construction. New engagement types, customer segments, and business processes can be supported by authoring new templates and prompts rather than by engineering new workflow definitions, conditional branches, or integration mappings.

### Component 17: Contextual Pruning-Deterministic Data Reduction Pipeline (Pruning Module 210)

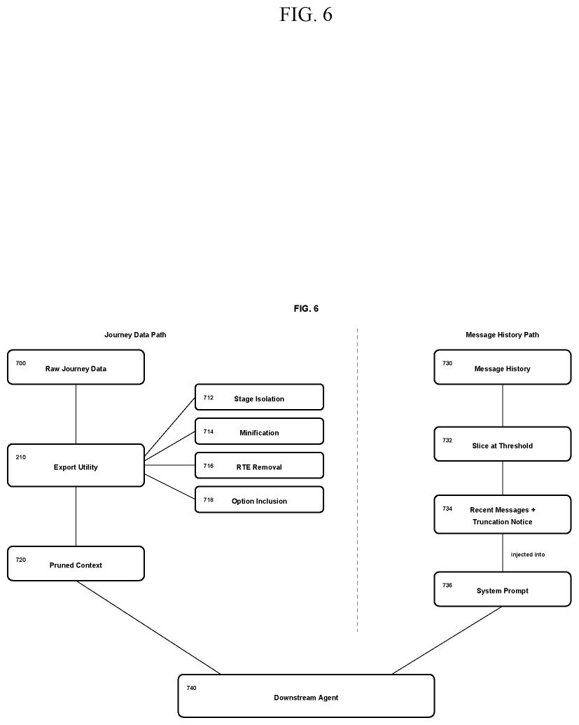

Referring to FIG. 6, the contextual pruning mechanism is a deterministic data reduction pipeline, not a summarization or content-filtering mechanism. The pipeline produces, for a given input state and a given set of parameters, a reduced data representation whose content is fully determined by the inputs. The properties of the pipeline are defined below.

### Pipeline Properties

1. Inclusion rules. Data that satisfies all inclusion criteria (stage scope, field type, presence requirements) is included in the output. Stage-scoped structured outputs associated with the stage specified by the isolateStage parameter are included.
2. Exclusion rules. Data that satisfies any exclusion criterion is excluded from the output. Stage-scoped outputs not associated with the specified stage are always excluded when isolateStage is specified. Free-form conversational dialogue between agents that does not carry a structured update is excluded. Fields marked as internal or diagnostic in the schema are excluded.
3. Transformation rules. Included data is transformed prior to output. HTML and rich text editor markup is stripped from string fields per a predefined markup specification. Whitespace and structural padding are removed when minifyData is enabled. Record identifiers are stripped when includeId is disabled. Predefined option sets are stripped when includeOptions is disabled.
4. Determinism. For any given (shared contextual state, parameter set) pair, the output of the pipeline is identical on every invocation. The pipeline performs no sampling, no heuristic selection, and no language-model inference. No state external to the (shared contextual state, parameter set) pair influences the output. The pipeline is therefore a pure function of its inputs.

The pipeline properties above distinguish the pruning module from summarization systems, which apply language-model inference to generate reduced content and therefore produce non-deterministic output, and from content-filtering systems, which apply quality or safety classifiers whose decisions may vary across invocations. The pruning module's determinism is a material property: downstream agents receive bounded, reproducible context, and failures can be traced to specific inputs rather than to opaque model behavior.

The pruning module 210 generates structured, high-signal context handoffs between AI agents by removing irrelevant dialogue and distilling key user inputs, decisions, and outcomes from upstream interactions.

### Export Utility

An ExportDataForCnode utility implements the pruning logic. The utility accepts the following parameters:
isolateStage: When specified, restricts the exported data to a single stage of the journey instance, preventing downstream agents from receiving data from stages outside their scoped responsibility.
minifyData: When enabled, removes whitespace, empty fields, and structural padding from the exported data, reducing prompt token consumption.
pruneRTE: When enabled, strips HTML and rich text editor (RTE) markup from all content fields before LLM exposure. This stripping serves dual purposes: reducing token consumption and preventing prompt injection through embedded markup.
includeOptions: When enabled, includes predefined selectable options (dropdown choices) in the exported data. When disabled, these options are omitted to reduce context size for agents that do not need them.
includeId: When enabled, includes record identifiers in the exported data. When disabled, identifiers are omitted to reduce context size for agents that only need content.

### Message History Slicing

The pruning module 210 enforces a configurable message history limit defined by the SLICE_MSG_HISTORY_FOR_API_AT constant, set to eight by default. When the conversation history exceeds this limit, the pruning module 210 retains only the most recent eight messages and injects a truncation notice: “History truncated, you have full context in system prompt.” The full session context is simultaneously embedded in the system prompt, ensuring that the LLM retains access to all decision-relevant information despite the truncated message history.

### Stage Isolation

When isolateStage is specified, the pruning module 210 exports data from only the specified stage. Downstream agents operating in the scope phase receive only scope-related data; agents operating in the deployment phase receive only deployment-related data augmented by structured outputs from upstream phases. This isolation prevents context pollution and ensures that each agent operates on a focused, relevant dataset.

### Component 18: Zero-Training AI Architecture

The system 100 achieves AI agent specialization without per-tenant or per-user fine-tuning of the underlying large language models. Specialization is accomplished through three mechanisms operating in combination:
1. Structured prompt engineering: Each agent receives a carefully constructed system prompt that defines its role, behavioral constraints, output format requirements, and contextual scope. The prompt transforms a general-purpose LLM into a specialized agent without modifying model weights.
2. Contextual chaining: Agents receive outputs from upstream agents as part of their input context, enabling them to build upon prior work without requiring training on historical interaction data. The chain of context flows through the shared contextual state maintained by the orchestration engine 110.
3. FSM governance: The FSM module 120 constrains the LLM's behavior to a finite set of allowable states and transitions, preventing the LLM from deviating from the intended conversational flow regardless of the specific LLM implementation in use.

This zero-training architecture eliminates the data collection, annotation, training, and validation cycle required by conventional ML-based customer engagement systems. New tenants can deploy the system immediately without accumulating proprietary training datasets.

### Component 19: Pluggable LLM Architecture (LLM Interface 130)

The LLM interface 130 decouples agent behavior from any specific LLM implementation. The system 100 defines four model selection categories:
SMARTER_MODEL: The primary reasoning model optimized for complex inference, nuanced conversation, and sophisticated output generation. Currently configured as gpt-5-mini, but replaceable with any model meeting the interface contract.
FASTER_MODEL: A lower-latency model optimized for rapid response generation in simpler interaction contexts. Currently configured as gpt-4o-mini.
RESEARCH_MODEL: A model optimized for extended reasoning, analysis, and research tasks requiring deeper contextual processing.
IMAGE_MODEL: A model optimized for image generation and visual content creation tasks.

A _validate_model_or_raise() function ensures that only valid, configured models are used by agents. This validation prevents runtime failures from misconfigured model references and enforces the model selection policy defined by the system administrator.

The FSM transition rules defined by the FSM module 120, the output schemas enforced by the validation module 140, and the prompt structures constructed by each agent remain invariant across different LLM selections. This invariance enables users to select models based on performance, cost, latency, or data privacy requirements without affecting agent behavior or system correctness. The architecture supports deployment across public cloud LLM services, private on-premises LLM instances, or hybrid configurations combining both.

### Component 20: First-Party Data Acquisition

The system 100 operates exclusively on first-party data provided directly by users interacting with the system. No external data APIs, third-party enrichment services, or inferred behavioral signals are used. All data within the system originates from one of two sources:
1. User-generated data: Information entered by users through conversational interactions with AI agents, form inputs, meeting notes, scope decisions, deployment status updates, and commitment acknowledgments.
2. User-uploaded data: Files and documents uploaded by users through the knowledge asset processor 280. The processor 280 supports the following file formats:
DOCX: Parsed using document structure extraction to extract paragraphs, tables, headers, and metadata.
XLSX: Parsed using spreadsheet processing libraries to extract cell values, sheet structures, and named ranges.
PDF: Processed using OCR (Optical Character Recognition) for scanned documents and direct text extraction for digitally-created documents.

Uploaded knowledge assets are processed, indexed, and made available as contextual inputs to AI agents operating within the journey instance. The user retains real-time control over their data and influence over AI behavior through direct interaction.

### Component 21: Data Privacy and Audit (audit Module 300)

The audit module 300 maintains a comprehensive audit trail recording every data modification within the system 100. The audit trail uses an edits model that records the following fields for each change:
user: The identifier of the user who performed the modification.
datetime: The timestamp of the modification.
editType: A categorical indicator of the type of modification (create, update, delete, status change).
editRowId: The identifier of the affected record.

A views model records session-level engagement data comprising open and close timestamps for each user session, enabling engagement duration analysis and activity pattern detection.

### Encryption

The system 100 implements layered encryption:
In transit: All data transmitted between clients and servers is encrypted using SSL/TLS protocols.
At rest: Server storage volumes are encrypted using LUKS (Linux Unified Key Setup) full-disk encryption.
Backups: All backup archives are encrypted using AES-256 encryption.

The first-party data architecture ensures data provenance (every data element can be traced to a specific user interaction), reduces compliance risk (no third-party data dependencies introduce regulatory ambiguity), and maintains a persistent link between user-supplied context and AI engine behavior (the AI operates only on data the user has provided or generated).

### Component 22: Taxonomy-Driven Template Generation Pipeline (Template Library 180, Agent Hierarchy Module 240, Template Evolution Engine 260, Marketplace Module 250)

The system 100 provides a structured pipeline for generating domain-specific journey templates at scale through a hierarchical classification taxonomy, three-prompt seeding, and multi-pass quality scoring. This pipeline supplies pre-built templates to the template library 180, supplies framework categories and framework tags to the marketplace module 250, supplies calibrated input prompts to the journey creator AI agent described in Component 3, and supplies per-template quality metadata to the template evolution engine 260.

### Hierarchical Taxonomy Data Structure

In one embodiment, the system 100 maintains a hierarchical taxonomy data structure comprising four levels of classification. The top level is a sector (for example, Technology; Industrial and Manufacturing; Health, Education and Government; Financial Services; Professional Services; Consumer). The second level is an industry within a sector (for example, Semiconductor and Chip Design within Technology). The third level is a sub-industry within an industry. The fourth level is an anchor, defined as a leaf-level noun phrase identifying a specific engagement type (for example, PCB Design, Custom Home Build, Clinical Trial Startup). Other embodiments may use more or fewer hierarchy levels and alternative category labels without departing from the scope of the invention.

Each anchor row stores, in addition to the four-level classification, a set of example companies serving as peer references for end-user trust and writer context, a three-prompt seed bundle, an industry tagline, and quality scoring metadata. The taxonomy provides cognitive navigation for users selecting pre-built templates from the template library 180, the hierarchy Sector to Industry to Sub-Industry to Anchor serving as a navigation path. The taxonomy also provides the classification keys consumed by the marketplace module 250, wherein sector and industry levels map to the templateFramework model defined in Component 4, and anchor-level groupings map to the templateFrameworkTag model.

### Anchor Naming Constraints

Each anchor is required to satisfy constraints that preserve cognitive navigability and trust. The anchor length is constrained to two to six words. The anchor part of speech is constrained to a noun phrase containing no verbs. The anchor must satisfy a semantic test wherein the anchor fits the sentence fragment “My company does ______” when read by a practitioner in the relevant domain. The anchor language is constrained to insider-native terminology, avoiding generic marketing terms such as “initiative,” “program,” or “rollout,” and avoiding generic process verbs such as “implementing,” “deploying,” “managing,” or “coordinating.” These constraints ensure that end-users navigating the template library 180 experience taxonomic recognition at each level of the hierarchy rather than encountering abstract category names.

### Three-Prompt Seeding

For each anchor, the system 100 stores a bundle of three natural-language prompts corresponding to the business inputs consumed by the journey creator AI agent described in Component 3. The seller prompt is a first-person-plural description of the seller's business, written from the seller's perspective and opening with phrasing such as “We are” or “We provide.” The buyer prompt is a description of the seller's typical customer, written in the seller's voice describing the buyer and opening with phrasing such as “Our customers are.” The offering prompt is a third-person description of the offering, describing its capabilities, evaluation criteria, and adoption pattern.

When a user selects an anchor from the taxonomy through the template library 180 user interface, the stored three-prompt seed bundle is transmitted to the journey creator AI agent as the entity description, guest description, and offering description inputs specified in Component 3. The three-prompt seeding mechanism is one embodiment of the business inputs consumed by the journey creator; other embodiments may use any number of business inputs of any form capable of conveying entity, counterparty, and offering context. The journey creator AI agent produces a pre-built journey template without requiring the user to author prompts from scratch. The user may subsequently refine the seed prompts and regenerate the template, or accept the pre-built template for instantiation as a journey instance.

Each prompt is bounded in length to a configurable range (for example, forty words minimum to one hundred fifty words maximum), with length scaling to engagement complexity. Prompts are required to stand alone, meaning that the journey creator AI agent receives only the three prompts and not the taxonomy hierarchy or example companies, ensuring that the prompts themselves contain sufficient context for template generation.

### Multi-Pass Prompt Generation Pipeline

The system 100 generates the three-prompt seed bundle for each anchor through a multi-pass pipeline comprising writer agents, reviewer agents, and conditional rewriter agents operating under coordination of the agent hierarchy module 240.

Pass One, Parallel Writing. A plurality of writer agents operates in parallel, one writer agent per sector. Each writer agent reads the anchor rows for its assigned sector, processes rows in sub-batches of configurable size, and generates three prompts per anchor. Writer outputs are persisted to sector-scoped output files to enable resumable operation and audit. The writer agents are seeded with a set of calibration examples that define the quality bar and voice expectations, ensuring consistency of texture across sectors and across writers.

Pass One, Parallel Review. After all writer agents complete, a plurality of reviewer agents operates in parallel, one reviewer agent per sector. Each reviewer agent reads the writer output for its sector without shared state from the writing phase, enabling fresh evaluation. The reviewer agent scores each anchor across four criteria, each scored on a zero-to-twenty-five scale: (1) insider voice, measuring use of terminology and process details characteristic of practitioners in the relevant domain; (2) buyer specificity, measuring naming of real roles, real pressures, real decision processes, and real evaluation criteria; (3) offering clarity, measuring description of what the offering does, how it is evaluated, and what adoption actually requires; and (4) composite integrity, measuring whether the prompts read as one business rather than as an amalgam of multiple business models. The total score is the sum of the four criteria, with a predetermined pass threshold (for example, eighty-five out of one hundred). Each row receives a binary pass/fail decision, a per-criterion score breakdown, and a natural-language critique when the row fails.

Cross-Row Uniqueness Detection. In addition to per-row scoring, the reviewer agent performs cross-row uniqueness analysis across all rows within its sector. Repeated phrases or patterns across multiple rows (for example, a phrase such as “consultative sales motion” appearing in twelve rows of a sector) are flagged as pattern failures even when individual rows might otherwise pass. This mechanism detects generic filler language that is individually plausible but collectively indicates insufficient domain specificity, and it produces critiques that instruct the rewriter to replace repeated phrases with domain-specific alternatives.

Pass Two, Rewrite Failed Rows. For rows that fail pass one review, a rewriter agent receives the original prompts, the per-criterion score breakdown, and the reviewer critique. The rewriter is instructed to modify only the weak areas identified by the critique and to preserve elements that scored well. Rewriter outputs are persisted to a pass-two output file.

Pass Two, Re-Review. The reviewer agent re-scores the rewritten rows using the same four-criteria rubric and threshold. Rows that now pass are admitted to the final dataset. Rows that still fail proceed to pass three.

Pass Three, Final Rewrite and Escalation. A final rewrite pass is attempted for rows that failed pass two, with a sharpened critique focused on the residual weaknesses. Rows that still fail after pass three are marked for manual review, indicating that the underlying anchor definition may require structural revision rather than prompt refinement alone. This distinction between prompt failure and anchor failure is preserved in the quality metadata and surfaced to the template evolution engine 260 as a signal that the anchor itself may require taxonomic rework.

### Calibration-Seeded Quality Baseline

The writer agents and reviewer agents are seeded with a set of calibration examples (for example, three calibration anchors drawn from semantically distant sectors such as Technology, Consumer, and Health, Education and Government) that collectively define the quality bar. Each calibration example comprises an anchor name, a completed three-prompt bundle that exemplifies insider voice and composite integrity, and an annotation identifying which textual features earn which score on which criterion. Calibration examples are injected into the writer agent system prompts to establish a texture baseline, and into the reviewer agent system prompts to establish a scoring baseline, ensuring that quality assessments remain consistent across writers, reviewers, and sectors.

### Quality Metadata Persistence and Feedback Loop

For each anchor, the system 100 persists the per-anchor score, the per-criterion breakdown, the pass number at which the anchor achieved a passing score (pass one, pass two, pass three, or manual review), the pass/fail status, and any critiques generated during review. This quality metadata is indexed in the template library 180 and is consumed by the template evolution engine 260 through the same template row identifier lineage described in Component 6. When an instance derived from a template produces a negative result state, the template evolution engine 260 can trace the negative outcome back to the prompt quality metadata, enabling correlation of template generation quality with journey outcome quality and triggering regeneration or rewrite of the underlying prompts when correlations indicate systematic prompt weakness.

### Sector-Sharded Data Architecture

The pipeline partitions taxonomy data by sector to enable parallel execution across sectors without cross-shard contention. Each sector has its own prompts file, scores file, and rewrites file, with file paths keyed by sector name. Writer and reviewer agents operating on different sectors execute concurrently without data conflicts because each agent reads and writes only to its own sector shard. Within a shard, operations are serialized through the sub-batch structure: a writer agent completes a sub-batch before advancing to the next sub-batch within the same sector, ensuring deterministic progress and resumability on failure.

### Integration With System 100

The taxonomy-driven template generation pipeline is not a separate system but a coordinated orchestration of existing components. The pipeline integrates with the template library 180 by populating the library with pre-built templates keyed by anchor identifiers. The pipeline integrates with the marketplace module 250 by deriving framework categories and framework tags from the sector, industry, and anchor levels of the taxonomy. The pipeline integrates with the agent hierarchy module 240 by providing the seller, buyer, and offering input prompts required by the journey creator AI agent in Component 3. The pipeline integrates with the template evolution engine 260 by providing per-anchor quality metadata that drives downstream template improvement decisions. The pipeline integrates with the validation module 140 by producing JSON-structured outputs conforming to a predetermined schema at each pass, with validation failures triggering rewrite rather than state advancement. The pipeline integrates with the first-party data architecture described in Component 20 by operating exclusively on user-authored taxonomy inputs and user-uploaded example company data, without third-party enrichment.

### DETAILED DESCRIPTION OF PREFERRED EMBODIMENTS

### Embodiment 1: Multi-Entity Evaluation Execution Flow Between Two Organizations

Referring to FIGS. 1 through 5, a first preferred embodiment of the system 100 is described in the context of a first entity (Entity A) and a second entity (Entity B) executing a multi-phase evaluation flow mediated by the system 100. Entity A and Entity B are illustrative; the embodiment is not limited to any particular domain.

Template Selection and Instance Instantiation. An operator at Entity A accesses the template library 180 through the marketplace module 250 and selects an execution template categorized under a multi-phase evaluation framework. The template comprises five stages: Discovery, Scope, Commit, Deploy, and Meetings. The orchestration engine 110 instantiates an execution instance from the selected template, assigning UUID primary keys to the instance object and all subordinate stage objects. Template row identifiers (template_rowId) are assigned to each element, linking the instance to its template lineage for subsequent analysis by the template evolution engine 260.

Alternatively, the operator may invoke the hierarchical template generation subsystem within the agent hierarchy module 240, providing a first entity description identifying Entity A, a second entity description identifying Entity B, and an offering description identifying the subject of the evaluation. The top-level creator agent generates a template blueprint, delegates to phase-specific subordinate agents for detailed population, and presents the completed template for review.

FSM-Driven Discovery. A principal associated with Entity B receives an access link generated by the concurrent multi-agent state synchronization subsystem (module 230) and enters the discovery phase. The Smart Conversation Discovery AI Agent, operating under FSM module 120 control, initiates the structured conversation. The session state module 150 initializes the session state dictionary with current_question_id set to the first discovery question, current_section_index set to zero, and empty sets for skipped_questions_set and answered_questions_set.

As the principal responds to discovery questions, the FSM transitions through answer-and-advance states. When the principal asks a clarifying question about a technical capability, the FSM enters the revise-and-reengage state: the LLM interface 130 generates a response addressing the clarification and re-asks the original question. When the principal skips a question outside the principal's scope of responsibility, the FSM enters the skip state and the question identifier is added to skipped_questions_set.

At question milestones (5, 10, 20 questions answered), the system generates progress notifications. Upon reaching has_completed_all status with three questions in skipped_questions_set, the system generates a CTA offering to revisit skipped questions.

CTA Orchestration. Throughout the execution flow, the CTA generator 160 produces context-sensitive directives. Upon discovery completion, a CTA prompts Entity A to review discovery outputs and initiate scope definition. The dispatch table 170 routes this CTA to the scope_answer_field_update handler, which creates initial scope modules populated with structured data from discovery outputs. Each database mutation executes within transaction. atomic() with select_for_update() row locks. State updates broadcast via the WebSocket communication layer 310 as multi_update_array messages, ensuring all connected clients observe the updated state in real time.

Predictive Scoring. As the execution instance progresses, the predictive engine 190 computes a predictive score. A FeatureExtractor extracts seventy-two features from the execution instance including discovery completion percentage (92%), time in discovery phase (7 working days), questions answered (47 of 50), scope modules accepted (3 of 5), meetings completed (2 of 4), and the operator's historical success rate (0.73). The InstantPredictor applies the formula: prediction=0.68+sum(weight_i (normalized_i−0.5) 0.1), computing a score of 0.81. The explainable output identifies the top contributing features: high discovery completion rate (+0.04), strong meeting attendance (+0.03), and above-average operator success rate (+0.02). The trust grade is B/A/B (performance/overfitting/data quantity).

Deployment Planning. When Entity B accepts the proposed scope, the DAG scheduler 200 generates a deployment plan. The DurationPropagator executes Kahn's algorithm to topologically sort 23 deployment tasks with 31 dependency edges. The critical path comprises 8 tasks spanning 47 working days. The DeploySchedulingOptions configuration excludes configured holidays and weekends. The duration optimizer 270 retrieves historical actual durations from 14 previously completed execution instances sharing the same template lineage, computes P75 duration estimates, and applies them to the plan. The optimized critical path extends to 52 working days, reflecting conservative estimates informed by historical evidence.

Concurrent Multi-Agent State Synchronization. The permission controller 290 manages access for multiple participant entities: an Entity A coordinator (coordinator role), an Entity A technical principal (supereditor role), an Entity B primary principal (guest admin role), an Entity B technical principal (guest editor role), and an Entity B procurement principal (guest viewer role via one-time link with seven-day expiry). Identity-domain-based access restrictions limit guest access to principals with matching identity domains. The concurrent multi-agent state synchronization module 230 aggregates asynchronous structured writes from all participant entities into the shared contextual state through serialized write operations with row-level locking.

Execution State Monitoring. The health monitor 220 tracks activity timestamps and stage completion indicators. After two weeks without guest-role activity, the monitor detects threshold breach: time elapsed since the last guest-role activity timestamp exceeds the configured threshold, and the scope stage shows numCompleteLineItems at 3 of 8. The monitor emits a structured intervention signal to the top-level orchestration agent, which generates a re-engagement CTA targeting the three outstanding scope modules.

Template Refinement. The Entity A operator invokes the hierarchical template refinement subsystem. The supervisory editing agent identifies that three deployment tasks lack assigned owners and that two scope modules contain placeholder descriptions. Phase-specific editing agents generate refined content for each identified gap, executing non-destructive modifications that preserve all existing first-party data.

First-Party Data and Knowledge Assets. An Entity B principal uploads a technical requirements document (DOCX) and a current systems inventory (XLSX) through the knowledge asset processor 280. The processor 280 extracts structured data from both documents and makes it available as contextual input to discovery and scope agents, enriching the system's working context for Entity B without relying on third-party data sources.

Pluggable LLMs. The operator configures the system to use SMARTER_MODEL for discovery conversations (requiring nuanced dialogue) and FASTER_MODEL for deployment task generation (requiring rapid output). The _validate_model_or_raise() function ensures valid model selection. The FSM transition rules and output schemas remain identical regardless of which model processes each interaction.

External System Integration. The system 100 exposes execution instance state, predictive scores, and monitoring metrics through API endpoints consumable by external systems operated by Entity A. External integration operates as a downstream consumer of the system's structured outputs, receiving updates via webhook notifications triggered by the WebSocket communication layer 310.

### Embodiment 2: Multi-Phase Enrollment Execution Flow in an Educational Context

Referring to FIGS. 1 through 5, a second preferred embodiment of the system 100 is described in the context of an educational institution executing a prospective-enrollee evaluation and enrollment flow. This embodiment is described to illustrate the domain-agnostic adaptability of the system 100 architecture; the described domain is not limiting.

Template and Instance Instantiation. An institutional operator accesses the template library 180 and selects an enrollment execution template within an educational-domain framework. The orchestration engine 110 instantiates an execution instance comprising five stages: Discovery (candidate evaluation), Scope (program-fit assessment), Commit (enrollment commitment process), Deploy (onboarding), and Meetings (in-person evaluations). Template row identifiers link each instance element to the enrollment template, enabling the template evolution engine 260 to analyze outcome patterns across cohorts.

Discovery Phase: Structured Profile Collection. The Smart Conversation Discovery AI Agent engages a prospective enrollee through conversational discovery. The session state module 150 tracks progress across three sections: academic profile, domain-specific statistical profile, and fit-related preferences.

The FSM module 120 governs the conversation. When the principal provides structured statistics, the FSM transitions through answer-and-advance states with the validation module 140 verifying structured updates. When the principal expresses confusion about an eligibility rule, the FSM enters the revise-and-reengage state, and the LLM interface 130 provides a clarifying response before re-asking the relevant question. When the principal skips a sensitive question, the FSM enters the skip state. Progress milestones generate notifications at 5 and 10 questions completed.

For dropdown-type questions (e.g., a division preference selection from a predefined option set), the validation module 140 verifies that the LLM-selected option matches one of the predefined choices. If the LLM generates an invalid option, a re-engagement prompt presents the valid selections.

Scope Phase: Program-Fit Evaluation. Upon discovery completion, the pruning module 210 generates a pruned context containing the principal's academic profile, domain-specific statistics, and stated preferences, stripped of conversational dialogue and RTE markup. Scope agents evaluate program-fit parameters against the collected data. The CTA generator 160 produces CTAs for institutional staff to confirm program-fit assessments. The dispatch table 170 routes updates through scope_answer_field_update and proposed_scope_table_update handlers.

Deployment Phase: Onboarding Plan. The DAG scheduler 200 generates an onboarding plan. Deployment tasks include representative institutional onboarding steps with dependency edges (e.g., an in-person evaluation precedes a commitment step; a compliance review precedes a binding signature). Workday-aware scheduling via DeploySchedulingOptions accounts for institution-specific calendar dates and domain-specific blackout periods.

Concurrent Multi-Agent State Synchronization. The permission controller 290 manages access for multiple participant entities with distinct roles:
Institutional coordinator: Coordinator role with full access across all stages.
Institutional reviewer: Supereditor role scoped to discovery and scope stages.
External evaluator: Guest editor role with access to evaluation tasks.
Compliance reviewer: Guest editor role with access to compliance-related deployment tasks and commit milestones.
Prospective enrollee: Guest admin role with access to discovery, scope, and meetings stages.
Secondary principal: Guest viewer role via standing link with access to scope and commit stages.

Identity-domain-based access restrictions via guestAllowedDomains ensure that institutional access links resolve only for principals with matching identity domains. The concurrent multi-agent state synchronization module 230 aggregates asynchronous structured writes: the compliance reviewer writes during business hours, the prospective enrollee writes in the evening, and the institutional coordinator writes on weekends. All writes merge into the shared contextual state through serialized operations with row-level locking.

Execution State Monitoring for Activity Drop-off. The health monitor 220 tracks activity timestamps and per-role write counts. Stage completion counters monitor discovery progress (numCompleteLineItems: 28 of 35), scope progress (numCompleteLineItems: 4 of 7), and deployment progress (numCompleteLineItems: 2 of 12). When time elapsed since last activity exceeds the configured threshold (e.g., 10 days during the scope phase), the health monitor 220 emits a structured intervention signal to the top-level orchestration agent. A re-engagement CTA is generated addressing the outstanding items.

The InstanceSummary daily aggregation tracks cohort-level metrics, enabling institutional staff to compare activity levels across all active execution instances and prioritize follow-up resources.

Predictive Scoring for Outcome Likelihood. The predictive engine 190 computes an outcome-likelihood score. The FeatureExtractor extracts features including: discovery completion rate (80%), in-person evaluation completion (1 of 2), academic evaluation score, domain-specific evaluation score, days since last activity, number of meetings completed, and the operator's historical success rate. The InstantPredictor computes a classification-mode prediction: probability of a successful outcome. The explainable output identifies in-person evaluation completion as the strongest positive predictor (+0.06) and extended inactivity as the strongest negative predictor (−0.04). The trust grade reflects data quantity from three prior cohorts.

Architecture Adaptability. This embodiment demonstrates that the identical system architecture used in Embodiment 1 adapts to a fundamentally different domain without modification to any system component. The FSM module 120 governs discovery conversations using the same state machine. The validation module 140 enforces the same output schemas. The DAG scheduler 200 applies the same scheduling algorithms. The predictive engine 190 uses the same empirical lifts formula. The only elements that differ are the template content (questions, scope modules, deployment tasks) and the prompt configurations supplied to the LLM interface 130. This domain-agnostic adaptability is a direct consequence of the zero-training architecture (Component 18) and the separation of system behavior from content configuration.

### Operational Benefits

The system 100 provides the following operational benefits attributable to its architectural design:

Zero-configuration deployment. The zero-training architecture enables new tenants to begin executing multi-phase flows immediately upon provisioning. No data collection period, model training cycle, or workflow design phase is required. The combination of structured prompt engineering, FSM governance, and template-based content configuration eliminates the setup overhead associated with conventional platforms requiring per-domain training.

Structured data collection through constrained conversation. The Smart Conversation Discovery AI Agent transforms structured data collection from a form-filling exercise into a governed natural-language dialogue. The four-state FSM ensures that the conversation remains productive (re-engaging non-responsive principals, answering clarifying questions, accommodating skips) while the validation module 140 guarantees that every accepted response produces a valid structured update.

Real-time multi-participant state propagation. The WebSocket communication layer 310 ensures that all connected clients observe execution instance state changes in real time. Database mutations broadcast as multi_update_array messages eliminate the latency between one participant entity's write and another participant entity's observation of that write, reducing synchronization overhead in multi-participant execution flows.

Explainable predictions. The predictive engine 190 produces weighted breakdowns of contributing features rather than opaque scores. An operator can identify which specific features drive the predicted outcome, enabling targeted intervention rather than general-purpose follow-up.

Adaptive scheduling. The DAG scheduler 200 produces deployment plans that reflect the actual state of the execution instance rather than generic templates. Historical duration optimization through the duration optimizer 270 grounds time estimates in empirical evidence from comparable past execution instances.

### Performance Advantages

The system 100 achieves the following performance advantages over prior art systems:

Reduced computational cost through contextual pruning. The pruning module 210 reduces prompt token consumption by stripping irrelevant dialogue, HTML markup, and non-essential metadata before transmitting context to downstream agents. Message history slicing limits the transmitted history to eight messages while compensating with full context in the system prompt. These mechanisms reduce LLM inference costs proportionally to the ratio of pruned tokens to total tokens.

Deterministic behavior through FSM governance. The FSM module 120 eliminates the unpredictability inherent in unconstrained LLM conversations. State transitions occur if and only if the validation module 140 confirms schema compliance, preventing hallucinated outputs from corrupting system state. This determinism enables the system 100 to operate in contexts where auditability and explainability are mandatory.

Concurrent scalability through atomic operations. The dispatch table 170 consumer action handlers execute database mutations within transaction. atomic() contexts with select_for_update() row-level locks. This concurrency control enables multiple participant entities and multiple AI agents to operate on the same execution instance simultaneously without data corruption or race conditions.

Model-agnostic performance optimization. The pluggable LLM architecture enables performance optimization through model selection. Computationally simple tasks can be routed to faster, less expensive models (FASTER_MODEL) while complex reasoning tasks are routed to more capable models (SMARTER_MODEL). This selective routing reduces average inference cost and latency without sacrificing output quality for complex interactions.

Efficient weight calibration. The predictive engine 190 calibrates feature weights once per twenty-four-hour cycle and caches the results. This amortization strategy avoids the computational cost of per-prediction weight computation while maintaining currency with evolving execution instance outcome data.

### Prototype Evidence

A working prototype of the system 100 is deployed and operational at CustomerNode.com. The prototype implements all components described in this specification, including the schema-gated state transition mechanism, the FSM-governed Smart Conversation Discovery AI Agent, the CTA-based transition system with dispatch table routing, the DAG-based deployment planning system with workday-aware scheduling, the empirical-lifts predictive scoring engine with LLM-calibrated weights, the concurrent multi-agent state synchronization subsystem with role-scoped permissions and identity-domain restrictions, the execution state monitoring subsystem with daily aggregation and intervention signals, the contextual pruning algorithm with stage isolation and markup removal, the template evolution engine with template row identifier lineage tracking, and the pluggable LLM architecture with model validation.

The prototype operates in a multi-tenant configuration serving production execution instances. Execution instances processed through the prototype demonstrate the system's ability to execute multi-phase flows through coordinated AI agents, produce validated structured outputs at each interaction turn, and adapt dynamically to input without predefined workflow logic.

The prototype validates the enablement of the claimed invention by demonstrating that a person having ordinary skill in the art can, using the descriptions and reference implementations provided in this specification, construct a fully operational system embodying each claimed component and the interactions among them.

### Domain Applicability

The system 100 architecture supports application across diverse domains and execution contexts. The domain-agnostic design, achieved through the separation of system behavior from content configuration, enables the identical architectural components to execute fundamentally different multi-phase flows through template variation alone. Additional representative contexts include, without limitation:
Multi-entity evaluation flows between two or more organizations, in which a structured discovery phase collects structured inputs from each participant entity, a scope phase defines agreed parameters, and a deployment phase manages parameterized execution tasks.
Consumer-facing high-consideration selection flows, in which a discovery phase collects structured preferences, a scope phase presents structured recommendations, and a deployment phase manages fulfillment.
Educational-domain enrollment flows (as described in Embodiment 2), in which a discovery phase collects academic and domain-specific profiles, a scope phase evaluates program fit, and a deployment phase manages enrollment steps.
Healthcare-domain intake and care-plan flows, in which a discovery phase collects structured medical history and preferences, a scope phase defines care parameters, and a deployment phase manages scheduling and milestone tracking; concurrent multi-agent state synchronization mediates interactions among multiple participant entities.
Regulatory and public-sector flows, in which a discovery phase collects applicant information, a scope phase evaluates eligibility, and a deployment phase manages processing steps and approvals.
Supply-chain qualification and procurement flows, in which a discovery phase collects specifications, a scope phase evaluates supplier capabilities, and a deployment phase manages procurement timelines.
Financial-services client-intake and origination flows, in which a discovery phase collects structured financial profiles, a scope phase defines service parameters, and a deployment phase manages activation steps.
Legal-domain intake and matter-management flows, in which a discovery phase collects structured case facts, a scope phase defines representation parameters, and a deployment phase manages filing deadlines.
Human-resources onboarding and role-transition flows, in which a discovery phase collects principal information, a scope phase defines onboarding parameters, and a deployment phase manages completion tracking.

In each context, the system 100 applies the same FSM-governed conversational AI (FSM module 120, validation module 140), the same CTA-based orchestration (CTA generator 160, dispatch table 170), the same predictive scoring (predictive engine 190), the same deployment planning (DAG scheduler 200), the same contextual pruning (pruning module 210), and the same concurrent multi-agent state synchronization (module 230). Only the template content, prompt configurations, and domain-specific feature definitions vary. This architectural consistency validates the system's domain-agnostic operation through configurable templates and zero-training AI agents.

### Non-Obvious Combination Effects

The system 100 produces technical effects that do not follow predictably from any component considered in isolation. These effects arise only from the specific combinations described below.

Effect A: Deterministic System Behavior from Non-Deterministic Language Model Output

A large language model, considered in isolation, produces probabilistic output that may include hallucinated content, malformed structures, or deviations from any requested format. A finite state machine, considered in isolation, produces deterministic transitions from valid inputs but produces undefined behavior from invalid inputs. A dispatch table, considered in isolation, routes well-formed instructions to handlers but cannot distinguish well-formed from malformed instructions. None of these components, alone or combined in routine fashion, produces deterministic, auditable system behavior when driven by LLM output.

The system 100 produces such behavior through the specific combination described in Component 0: every LLM candidate response is validated against a predetermined machine-parseable output schema before any state transition is permitted; validated responses are dispatched through the dispatch table to deterministic consumer action handlers executing atomic database mutations with row-level locking; state transitions, database mutations, and client broadcasts occur as a single indivisible operation; and validation failures are handled through a bounded retry mechanism with explicit freeze semantics. The combination converts probabilistic LLM output into deterministic system behavior, an effect that no component in the combination produces by itself.

### Effect B: Domain-Agnostic Operation Without Per-Domain Training

Prior customer engagement systems require per-tenant, per-user, or per-domain training before deployment. This training requirement is a predictable consequence of conventional machine learning architectures where behavior is encoded in learned model weights. The system 100 achieves specialized agent behavior across widely divergent domains, including enterprise software sales, student-athlete recruitment, healthcare patient onboarding, and legal client intake, without modifying any component of the system architecture and without per-domain training, as demonstrated in Embodiment 1 and Embodiment 2.

This domain-agnostic operation is a technical effect of the specific combination of three architectural choices: (i) FSM governance confines behavior to a defined set of states and transitions invariant across domains; (ii) schema-based output validation enforces structural conformance invariant across domains; and (iii) template-driven content configuration externalizes all domain-specific content to templates consumed by the same invariant agents. A person having ordinary skill in the art, presented with any subset of these three choices, would not predict that domain-agnostic operation is achievable without training, because each choice alone is consistent with a system that requires domain-specific training.

### Effect C: Unified State Progression and Persistence Through a Single Validated Output

Prior orchestration systems treat state transition and data persistence as separate operations. A state transition is triggered by one mechanism (user action, timer, rule evaluation) and persistence is handled by a different mechanism (database write, event log). Coupling the two requires additional coordination logic to maintain consistency.

The system 100 couples state transition and persistence through a single validated structured output. A successful schema validation simultaneously authorizes the FSM transition and provides the exact data payload that the consumer action handler writes to persistent storage, within a single atomic transaction with row-level locking. The two effects occur together or not at all. This unification eliminates the consistency coordination logic required by systems that treat transition and persistence separately, and produces an audit-ready record where every persistent change is traceable to a specific validated LLM output.

### Effect D: Bounded Context Size Without Information Loss Through Deterministic Pruning

Prior multi-agent AI systems face a predictable tradeoff: providing full accumulated context to downstream agents increases prompt size and cost, while ad hoc subset selection risks omitting decision-relevant information. Neither extreme is optimal. A person having ordinary skill in the art would expect any solution in this tradeoff space to require either heuristic tuning or explicit training.

The system 100's contextual pruning algorithm produces a reduced context whose content is fully determined by a small set of declarative parameters (stage isolation, minification, markup removal, option inclusion) and the current shared contextual state. The algorithm is deterministic, requires no training, and preserves all decision-relevant data within the configured stage boundary while excluding everything else. The combination of parametric control, deterministic inclusion rules, and first-party data provenance produces the observed effect of bounded context without information loss, an effect not achievable through any component of the combination alone.

1. A computer-implemented system for constraining probabilistic large language model output through enforced structural validation and state-controlled progression, the system comprising:
a processor; and
a non-transitory computer-readable memory storing instructions that, when executed by the processor, cause the system to:
maintain, for each interaction session, a session state data structure comprising a current question identifier, a current section index, a set of answered question identifiers, a set of skipped question identifiers, and a completion status indicator;
operate a finite state machine (FSM) defining a plurality of states including answer-and-advance, re-engage, revise-and-reengage, and skip, the FSM having a current state, wherein transitions between states are governed by deterministic transition rules evaluated against user input and the session state data structure;
for each interaction turn, generate a scoped prompt based on the current state of the FSM, a current question referenced by the current question identifier, and session context, and transmit the scoped prompt to a large language model (LLM) to produce a candidate response;
validate each candidate response against a predetermined machine-parseable output schema comprising a message field and a structured update field, wherein the structured update field encodes at least one data modification instruction, and wherein validation comprises verifying presence and type of required fields and, for questions having a predefined set of selectable options, verifying that a selected option in the structured update field matches one of the predefined selectable options;
permit a state transition from the current state to a subsequent state if and only if the candidate response satisfies the output schema validation, and upon validation failure (i) reject the candidate response, (ii) maintain the current state without updating the session state data structure, and (iii) generate a re-engagement prompt that is issued within the current state;
upon repeated validation failures exceeding a configured retry threshold, enter a non-progressing state in which further state transitions are disabled until receipt of a subsequent candidate response that satisfies the output schema validation or until receipt of an explicit user override;
upon successful validation, dispatch the structured update field to a consumer action handler selected from a dispatch table based on an action type identifier, the consumer action handler executing a corresponding database mutation within an atomic transaction with row-level locking, such that the state transition and the corresponding database mutation are committed as a single indivisible operation and no partial execution of the state transition without the corresponding database mutation, or of the database mutation without the corresponding state transition, is permitted;
wherein the structured update field constitutes the exclusive mechanism by which the session state data structure and persistent data tracked by the session state data structure are modified, such that no state transition and no mutation of the persistent data occurs outside execution of the dispatched structured update field; and
upon detecting that all questions in a section have been answered or explicitly skipped, transition the session to a subsequent section and update the session state data structure accordingly.

2. The system of claim 1, wherein the candidate response validation further comprises, for questions having a predefined set of selectable options, verifying that a selected option in the structured update field matches one of the predefined selectable options, and upon detecting an invalid selection, generating a re-engagement prompt listing the valid options.

3. The system of claim 1, wherein the session state data structure further comprises a has-completed-all-with-skips indicator, and wherein the system is further configured to, upon a user request to revisit skipped questions, re-enter the FSM at the first skipped question identifier and re-initiate conversational state transitions for each skipped question.

4. The system of claim 1, wherein the system is further configured to truncate a message history transmitted to the LLM to a predetermined number of recent messages, and to compensate for the truncation by including the full session context in a system prompt accompanying the scoped prompt.

5. The system of claim 1, wherein the LLM is selected from a plurality of available LLMs based on at least one of performance, cost, latency, or data privacy requirements, and wherein the FSM transition rules and the output schema remain invariant across different LLM selections.

6. The system of claim 1, wherein upon validation failure the system is further configured to increment a per-turn failure counter, to incorporate into the re-engagement prompt a reference to the specific output schema field that failed validation, and upon the failure counter exceeding a configured retry threshold to freeze the current state pending explicit user intervention.

7. A computer-implemented pipeline system for sequential stage-scoped AI agent execution with dispatch-table-routed state coordination, the system comprising:
a processor; and
a non-transitory computer-readable memory storing instructions that, when executed by the processor, cause the system to:
instantiate, from a template, an execution instance comprising a plurality of sequential stages, each stage having a stage-specific AI agent operating within a scoped context derived from the execution instance;
operate a top-level orchestration agent configured to delegate execution to the stage-specific AI agents, monitor stage completion indicators, and effect transitions between stages through a dispatch table;
generate, based on real-time execution context and stage outputs, structured Call-to-Action (CTA) directives, each CTA directive being a structured command object comprising an action type identifier and a parameter set, wherein each CTA directive is both rendered as an interactive user interface element and executed as a backend effect through the dispatch table without translation into any intermediate representation between rendering and execution, such that the same CTA directive produces both the user interface element and the backend effect without separate branching logic;
route each CTA directive, upon invocation, to a consumer action handler selected from the dispatch table based on the action type identifier, the consumer action handler executing a corresponding database mutation within an atomic transaction with row-level locking and broadcasting a state update to connected clients via a real-time communication channel;
wherein all backend mutations on data tracked by the execution instance are initiated exclusively through CTA directives routed via the dispatch table, such that no backend mutation on the data occurs outside execution of a CTA directive;
maintain a shared contextual state accessible to each stage-specific AI agent, wherein each agent contributes structured outputs that are aggregated into the shared contextual state; and
generate, for a downstream stage-specific AI agent, a pruned context by executing a contextual pruning algorithm that receives parameters specifying stage isolation, data minification, markup removal, and option inclusion, applies deterministic inclusion rules that preserve stage-scoped structured outputs and exclude out-of-stage data, strips rich text markup from included fields according to a predefined markup specification, and outputs a reduced data representation, wherein the contextual pruning algorithm produces identical outputs for identical inputs and parameter sets.

8. The system of claim 7, wherein instantiating the execution instance from the template further comprises assigning a template row identifier to each element of the execution instance, the template row identifier mapping each instance element back to its corresponding template element, enabling lineage tracking and template improvement based on instance outcomes.

9. The system of claim 7, further comprising a template generation subsystem configured to:
receive a set of structured inputs comprising at least a first entity description and an offering description;
transmit the structured inputs to an AI agent configured to generate an execution template comprising a plurality of stages, each stage populated with phase-appropriate content; and
present the generated execution template for review and optional refinement.

10. The system of claim 9, further comprising a template refinement subsystem configured to:
operate a supervisory editing AI agent that analyzes the execution template to detect refinement opportunities;
generate CTA directives that route an editing operation to phase-specific editing AI agents; and
execute non-destructive modifications to the execution template while preserving structural integrity.

11. The system of claim 8, further comprising a template library subsystem configured to:
store a plurality of execution templates organized by framework categories and framework tags;
publish selected execution templates to a shared library accessible to authorized users; and
instantiate new execution instances from published execution templates via a cloning operation that assigns new unique identifiers while preserving template row identifier mappings.

12. The system of claim 11, wherein the template library subsystem is further configured to accept template submissions from external creators, execute a conformance validation procedure comprising schema validation and structural integrity checks on each submitted template, and record licensing metadata associated with approved templates.

13. The system of claim 7, wherein the real-time communication channel comprises a WebSocket connection managed by an asynchronous consumer, the asynchronous consumer configured to:
add connected client sessions to a group associated with the execution instance;
track active client sessions per execution instance via a cached session list;
broadcast state updates to all group members upon any database mutation; and
record view analytics comprising connection timestamps and role identifiers.

14. The system of claim 7, wherein the plurality of sequential stages comprises at least a discovery stage, a scope stage, and a deployment stage, and wherein the system is further configured to propagate structured outputs from the discovery stage to the scope stage, and from the scope stage to the deployment stage, such that each downstream stage operates on contextual data derived from upstream stage outputs.

15. A computer-implemented system for generating a deployment plan from structured upstream outputs through deterministic directed-acyclic-graph-based scheduling, the system comprising:
a processor; and
a non-transitory computer-readable memory storing instructions that, when executed by the processor, cause the system to:
represent a set of deployment tasks as nodes in a directed acyclic graph (DAG), each node storing a task identifier, a task duration, a planned start date, a planned end date, and references to predecessor nodes and successor nodes, and each directed edge representing a dependency constraint requiring the predecessor node to complete before the successor node begins;
execute a topological sort on the DAG by (i) initializing, for each node, an in-degree counter equal to a count of incoming dependency edges, (ii) enqueuing each node with an in-degree counter of zero into a processing queue, and (iii) iteratively dequeuing a node from the processing queue, appending the dequeued node to an ordered output sequence, decrementing the in-degree counter of each successor node of the dequeued node, and enqueuing each successor node whose in-degree counter has reached zero, until the processing queue is empty;
for each node in the ordered output sequence, compute the planned start date as a maximum of the planned end dates of the node's predecessor nodes, or as a configured project start date if the node has no predecessor nodes;
compute the planned end date for each node by advancing the planned start date by the task duration using workday-aware scheduling that (i) consults a configured list of holiday dates to exclude from working-day calculations, (ii) consults a configured weekend-day indicator to exclude weekend days, and (iii) consults a configured working-hour window to bound within-day advancement;
identify a critical path through the DAG as a longest path, measured by cumulative task duration, from any node with no predecessor nodes to any node with no successor nodes;
upon any modification to a task duration or a dependency edge, perform backtracking re-propagation by re-executing the topological sort and re-computing the planned start date and planned end date for each affected ancestor node and descendant node, wherein the re-propagation executes within an atomic database transaction with row-level locking on the affected task records such that concurrent modifications to the DAG do not produce inconsistent planned dates; and
receive, as input to the deployment plan, structured outputs from one or more upstream stage-specific AI agents, wherein only structured outputs that have satisfied validation against a predetermined machine-parseable output schema are eligible for inclusion as input to the directed acyclic graph, such that no structured output that failed the validation is permitted to enter the deployment plan.

16. The system of claim 15, further comprising hierarchical duration aggregation, wherein one or more nodes in the DAG are parent nodes each associated with a plurality of child nodes, the parent node's task duration is computed as one of (i) a maximum of the child nodes' task durations or (ii) a sum of the child nodes' task durations, selected by a configured aggregation mode indicator, and a change in any child node's task duration triggers re-propagation of planned dates through all ancestor nodes of the changed child node and all descendant nodes dependent on the changed child node.

17. The system of claim 15, further comprising a duration optimization subsystem configured to:
retrieve, from a plurality of previously completed historical execution instances whose deployment tasks share a common template row identifier with one or more tasks of the deployment plan, historical actual start dates and actual end dates for the deployment tasks, and compute historical actual durations therefrom;
compute an optimized duration estimate from the historical actual durations using a configured statistical method selected from average, minimum, maximum, twenty-fifth percentile, and seventy-fifth percentile; and
apply the optimized duration estimate to the corresponding task in the DAG before or during execution of the topological sort.

18. The system of claim 15, further comprising a predictive scoring subsystem configured to:
extract, from each of a plurality of completed historical execution instances associated with a common template, a feature vector comprising normalized values derived from stage completion percentages, interaction frequency metrics, per-question response rates, and temporal progression indicators;
compute, for each feature, an empirical lift value representing a change in an empirical success rate observed when the feature value exceeds a configured threshold relative to a base success rate computed across all the completed historical execution instances;
transmit the features and corresponding empirical lift values to a large language model configured to produce calibrated weight assignments for each feature, and cache the weight assignments for a configured duration;
for a target execution instance, compute a predictive score equal to the base success rate plus a sum, over the features, of a product of the calibrated weight for the feature, a difference between the normalized feature value for the target execution instance and a centering offset of one-half, and a configured scaling factor;
generate an explainable output comprising the predictive score and a ranked breakdown of the features by magnitude of contribution to the predictive score.

19. The system of claim 18, wherein the predictive score computation is scoped to historical execution instances within a single tenant, the features are normalized using population-level minimum and maximum values computed across the tenant's completed execution instances, and the predictive scoring subsystem applies synthetic minority oversampling to handle class imbalance in the population, and wherein the predictive scoring subsystem is further configured to generate diagnostic metrics for the predictive model comprising accuracy, precision, recall, F1 score, area under the receiver operating characteristic curve, a confusion matrix, feature importance rankings, and a trust grade computed from a data quantity dimension and a model performance dimension.

20. The system of claim 7, further comprising a concurrent multi-agent state synchronization subsystem configured to:
assign role-scoped permission levels to a plurality of participant entities associated with the execution instance, the permission levels selected from at least viewer, editor, and administrator;
maintain, for each participant entity, a permission-filtered view of the shared contextual state;
aggregate asynchronous structured writes from the plurality of participant entities into the shared contextual state through serialized write operations with row-level locking; and
enforce identity-domain-based access restrictions based on a list of allowed identity domains associated with the execution instance.

21. The system of claim 7, further comprising an execution state monitoring subsystem configured to:
continuously track stage completion indicators, activity timestamps, and per-agent write counts;
maintain, for each execution instance, a result state identifier selected from active, success, not success, and on hold;
aggregate daily interaction summary records comprising per-role view counts and per-role write counts; and
emit structured intervention signals to the top-level orchestration agent when time elapsed since the last activity timestamp exceeds a configured threshold and stage completion indicators indicate incomplete stage transitions.

22. The system of claim 1, wherein all data processed by the system is first-party data received directly through system interfaces, without reliance on third-party data enrichment or inferred signals, and wherein the system maintains an audit trail recording each data modification with a timestamp, a principal identifier, an edit type, and an affected record identifier.

23. The system of claim 7, wherein the pruned context is generated by a data export utility configured to receive parameters specifying stage isolation, data minification, rich text markup removal, and option inclusion, and to output a reduced data representation containing only decision-relevant information for the downstream AI agent.

24. A computer-implemented system for constraining probabilistic generative model output through enforced structural validation and state-controlled progression, the system comprising:
a processor; and
a non-transitory computer-readable memory storing instructions that, when executed by the processor, cause the system to:
maintain, for each interaction session, a session state data structure that records progression of the session through a plurality of defined states;
operate a state-controlled progression mechanism that defines a set of allowable session states and a set of deterministic transition rules governing movement between the states, wherein the state-controlled progression mechanism is implemented as one of a finite state machine, a rule-based progression engine, a state chart, a workflow graph, or an equivalent deterministic state-transition structure;
for each interaction turn, generate a scoped prompt based on a current state of the state-controlled progression mechanism and session context, and transmit the scoped prompt to a probabilistic generative model to produce a candidate response, wherein the probabilistic generative model comprises one of a large language model, a transformer-based neural network, a generative neural model, or another probabilistic model configured to produce natural-language or structured output;
validate each candidate response against a predetermined machine-parseable output schema expressed in a structured data format, wherein the structured data format comprises one of JSON, XML, YAML, Protocol Buffers, a binary-encoded structured format, or an equivalent machine-parseable format, and wherein validation comprises verifying presence and type of required fields specified by the output schema;
permit a state transition from the current state to a subsequent state if and only if the candidate response satisfies the output schema validation, and upon validation failure reject the candidate response, maintain the current state, and generate a re-engagement prompt within the current state;
upon repeated validation failures exceeding a configured retry threshold, enter a non-progressing state in which further state transitions are disabled until a subsequent candidate response satisfies the output schema validation or an explicit operator override is received;
upon successful validation, route the validated structured output through a dispatch table to a consumer action handler that executes a corresponding database mutation within an atomic transaction with row-level locking, such that the state transition and the corresponding database mutation are committed as a single indivisible operation; and
wherein the validated structured output constitutes the exclusive mechanism by which the session state data structure and persistent data tracked by the session state data structure are modified.

25. The system of claim 1, wherein the output schema validation rejects as non-conforming any candidate response that is missing one or more required fields, such that partial or incomplete structured outputs do not trigger a state transition, do not trigger a database mutation, and do not trigger a client broadcast.

26. The system of claim 6, wherein the per-turn failure counter is bounded by a configured maximum retry count, and wherein upon the configured maximum retry count being exceeded, the system records the frozen state with a timestamp and a terminal failure code and emits an intervention signal that halts further state-transition attempts until the frozen state is explicitly cleared.

27. The system of claim 7, wherein the interactive user interface element rendered from the CTA directive is derived directly from the structured action type identifier and parameter set, such that the user interface element's label, affordance type, and input fields are determined by the structured content of the CTA directive without an intermediate translation layer between the structured directive and the rendered user interface element.
